(19) United States
(12) Patent Application Publication
(10) Pub. No.: US 2024/0243346 A1
(43) Pub. Date: Jul. 18, 2024

(54) POSITIVE ELECTRODE-SOLID ELECTROLYTE SUBASSEMBLY, ELECTROCHEMICAL CELL INCLUDING THE SAME, AND METHOD OF PREPARING THE SAME

(71) Applicant: Samsung SDI Co., Ltd., Yongin-si (KR)

(72) Inventors: Wonsung Choi, Suwon-si (KR); Junhwan Ku, Suwon-si (KR)

(21) Appl. No.: 18/358,254

(22) Filed: Jul. 25, 2023

(30) Foreign Application Priority Data
Dec. 28, 2022 (KR) 10-2022-0187762

(51) Int. Cl. H01M 10/0562; H01M 10/054

(52) U.S. Cl. CPC H01M 10/0562; H01M 10/054; H01M 2004/028

(57) ABSTRACT

A positive electrode-solid electrolyte subassembly includes a positive electrode including a positive electrode active material, a conductive material, and a first solid electrolyte, a second solid electrolyte disposed on the positive electrode, and an interlayer disposed between the positive electrode and the second solid electrolyte, wherein the interlayer includes an interlayer material, the interlayer material having an electrical conductivity less than an electrical conductivity of the conductive material of the positive electrode, and wherein the first solid electrolyte contains lithium and a metal, and a sulfur-free lithium-ion conductor.

### CROSS-REFERENCE TO RELATED APPLICATION

This application is based on and claims priority to Korean Patent Application No. 10-2022-0187762, filed on Dec. 28, 2022, in the Korean Intellectual Property Office, and all the benefits accruing therefrom under 35 U.S.C. § 119, the content of which is incorporated by reference herein in its entirety.

### BACKGROUND

### 1. Field

The disclosure is related to a positive electrode-solid electrolyte subassembly, an electrochemical cell including the same, and a method of preparing the same.

### 2. Description of the Related Art

An all-solid-state battery includes a solid electrolyte as an electrolyte. The all-solid-state battery does not include a flammable organic solvent, and thus has an excellent stability. Nonetheless, there remains a need for materials with improved stability.

### SUMMARY

According to an aspect, provided is a positive electrode-solid electrolyte subassembly by having a novel composition and structure.

According to another aspect, provided is an electrochemical cell including the above-mentioned positive electrode-solid electrolyte subassembly.

According to another aspect, provided is a method of preparing the above-mentioned positive electrode-solid electrolyte subassembly.

Additional aspects will be set forth in part in the description which follows and, in part, will be apparent from the description, or may be learned by practice of the presented embodiments of the disclosure.

According to an aspect, provided is a positive electrode-solid electrolyte subassembly including:
a positive electrode including a positive electrode active material, a conductive material, and a first solid electrolyte;
a second solid electrolyte disposed on the positive electrode; and
an interlayer disposed between the positive electrode and the second solid electrolyte, wherein the interlayer includes an interlayer material,
the interlayer material having an electrical conductivity less than an electrical conductivity of the conductive material of the positive electrode, and
wherein the first solid electrolyte contains lithium, and a metal, and
a sulfur-free lithium-ion conductor.

The interlayer may have an electrical conductivity of less than 1 Siemens per meter (S/m).

The conductive material of the positive electrode may be a carbon-based (i.e., carbon) material, and the carbon-based material may be graphite, carbon black, acetylene black, ketjen black, denka black, carbon fiber, carbon nanofiber, carbon nanotube, or a combination thereof.

The interlayer material may include a metal sulfide, a metal oxide, a lithium metal oxide, a metal halide, a metal nitride, a metal carbonate, or a combination thereof.

The metal sulfide may be a sulfide containing copper (Cu), tin (Sn), cobalt (Co), nickel (Ni), zinc (Zn), titanium (Ti), cadmium (Cd), molybdenum (Mo), palladium (Pd), rhodium (Rh), zirconium (Zr), vanadium (V), hafnium (Hf), tungsten (W), aluminum (Al), or a combination thereof,
the metal oxide may be zirconium dioxide (ZrO₂), aluminum oxide (Al₂O₃), silicon dioxide (SiO₂), zinc oxide (ZnO), hafnium dioxide (HfO₂), titanium dioxide (TiO₂), tin dioxide (SnO₂), or a combination thereof, and
the lithium metal oxide may be lithium zirconium oxide, lithium titanium oxide, or a combination thereof.

the lithium halide may be lithium chloride, lithium fluoride, lithium bromide, lithium iodide, or a combination thereof,
the metal carbonate may be lithium carbonate, magnesium carbonate, sodium carbonate, calcium carbonate, barium carbonate, or a combination thereof, and the metal nitride may be lithium nitride, titanium nitride, tantalum nitride, molybdenum nitride, vanadium nitride or a combination thereof.

The interlayer may have a thickness of about 1 nanometer to about 1 micrometer.

The second solid electrolyte may be a sulfide solid electrolyte, an oxide solid electrolyte, or a combination thereof.

The first solid electrolyte may include a solid ion conductor compound represented by Formula 1:

LiₓM1ₐM2_{b}Cl_{y}Br_{z} Formula 1

where M1 includes an alkali metal, an alkaline earth metal, a transition metal, or a combination thereof,
M2 is a lanthanide element, non-lanthanide element having oxidation number of 3, or a combination thereof, and

0<x<3.5,0≤a<1.5, 0<b<1.5, 0≤y<6, 0≤z<6, and 0<y+z≤6.

The M2 may be La, Ce, Pr, Nd, Pm, Sm, Eu, Gd, Tb, Dy, Ho, Er, Tm, Yb, Lu, Sc, Y, In, or a combination thereof, and M1 may be Na, K, Rb, Cs, Fr, Be, Mg, Ca, Sr, Ba, Ra, Sc, Y, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, In, Ti, Ge, Sn, Pb, Sb, Bi, Po or a combination thereof.

An ionic conductivity of the first solid electrolyte may be about 10⁻⁴ S/cm or greater at 20° C., and an ionic conductivity of the second solid electrolyte may be about 10⁻³ S/cm or greater at 20° C.

The first solid electrolyte is electrochemically stable in a potential window of about 0.6 volts (V) to about 4.2 V with respect to a lithium metal.

The second solid electrolyte is an argyrodite (e.g., argyrodite-based, or argyrodite-type) sulfide solid electrolyte.

The second solid electrolyte may be a sulfide solid electrolyte including Li₂S—P₂S₅, Li₂S—P₂S₅—LiX wherein X is a halogen element, Li₂S—P₂S₅—Li₂O, Li₂S—P₂S₅—Li₂O-Lil, Li₂S-SiS₂, Li₂S-SiS₂—Lil, Li₂S—SiS₂—LiBr, Li₂S—SiS₂—LiCl, Li₂S-SiS₂—B₂S₃—Lil, Li₂S-SiS₂—P₂S₅—Lil, Li₂S—B₂S₃, Li₂S—P₂S₅—ZₘSₙ wherein m and n are positive numbers, and Z is one of Ge, Zn, or Ga, Li₂S-GeS₂, Li₂S-SiS₂—Li₃PO₄, Li₂S-SiS₂—LiₚMO_{q} wherein p and q are positive numbers, and M is one of P, Si, Ge, B, Al, Ga, or In, Li₇₋ₓPS₆₋ₓClₓ (0<x<2), Li₇₋ₓPS₆₋ₓBrₓ (0<x<2), and Li₇₋ₓPS₆₋ₓlₓ (0<x<2), or a combination thereof.

According to another aspect, provided is an electrochemical cell including the above-mentioned positive electrode-solid electrolyte subassembly and a negative electrode,

wherein the solid electrolyte of the positive electrode-solid electrolyte subassembly is disposed between the positive electrode and the negative electrode.

The electrochemical cell may be an all-solid-state secondary battery.

The negative electrode may include a lithium metal or a lithium alloy.

According to another aspect, provided is a method of preparing a positive electrode-solid electrolyte assembly, the method including: providing a positive electrode including a positive electrode active material, a first solid electrolyte, and a conductive material;
treating a preliminary interlayer material to form an interlayer;
providing a second solid electrolyte; and
disposing the interlayer between the positive electrode and the second solid electrolyte to prepare the positive electrode-solid electrolyte subassembly.

The treating of the preliminary interlayer material may include sputtering or coating the preliminary interlayer material to form the interlayer on the substrate or the positive electrode.

The forming of the interlayer by disposing the preliminary interlayer material may include forming the interlayer containing copper sulfide by sputtering copper, or forming the interlayer containing zinc oxide by sputtering zinc.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a cross-sectional view of an embodiment illustrating a structure of a positive electrode-solid electrolyte assembly;

FIG. 1B is a cross-sectional view of an embodiment of an electrochemical cell containing a positive electrode-solid electrolyte;

FIGS. 2A to 2C are each a graph of binding energy (electronvolts, eV) vs. intensity (arbitrary units, a.u.) and shows the results of X-ray photoelectron spectroscopy (XPS) analysis for a surface of an interlayer after Cu sputter coating in a preparation process for an all-solid-state battery prepared according to Example 1;

FIGS. 3A to 3C are each a graph of binding energy (eV) vs. intensity (a.u.) and shows the results of XPS analysis for a surface of an interlayer after Zr sputter coating in a preparation process for an all-solid-state battery prepared according to Example 3;

FIGS. 4A and 4B are each a graph of capacity (milliampere-hours per square centimeter, mAh·cm⁻²) vs. voltage (volts, V), showing the charge/discharge characteristics of the all-solid-state secondary battery prepared according to Example 1;

FIGS. 5A and 5B are each a graph of capacity (mAh·cm⁻²) vs. voltage (V), showing the charge/discharge characteristics of an all-solid-state secondary battery prepared according to Comparative Example 1;

FIG. 6 is a graph of number of cycles vs. capacity (milliampere-hours per gram, mAh·g⁻¹) showing the lifetime characteristics of the all-solid-state secondary batteries prepared according to Example 1 and Comparative Example 1;

FIG. 7 is a schematic view of an embodiment of an all-solid-state secondary battery;

FIG. 8 is a schematic view of an embodiment of an all-solid-state secondary battery; and

FIG. 9 is a schematic view of an embodiment of an all-solid-state secondary battery.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein.

Accordingly, the embodiments are merely described below, by referring to the figures, to explain various aspects. As used herein, the term “and/or” includes any and all combinations of one or more of the associated listed items. Expressions such as “at least one of,” when preceding a list of elements, modify the entire list of elements and do not modify the individual elements of the list.

Various embodiments were illustrated in the accompanying drawings. The inventive concept may, however, be embodied in many other forms and should not be construed as being limited to the embodiments set forth herein. Rather, these embodiments are provided so that this disclosure will be thorough and complete, and will fully convey the scope of the inventive concept to those ordinary skilled in the art. Like reference numerals refer to like elements throughout.

It will be understood that when an element is referred to as being “on” another element, it can be directly on the other element or intervening elements may be present. In contrast, when an element is referred to as being “directly on” another element, there are no intervening elements.

It will be understood that, although the terms “first”, “second”, “third”, etc. may be used herein to describe various elements, components, regions, layers and/or sections, these elements, components, regions, layers and/or sections, should not be limited by these terms. These terms are only used to distinguish one element component, region, layer and/or section, from another. Thus, a first element, component, region, layer or section, discussed below could be termed a second element, component, region, layer and/or section, without departing from the teachings of the inventive concept.

The terminology used herein is for the purpose of describing particular example embodiments only and is not intended to be limiting of the inventive concept. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. As used herein, the singular forms are intended to include the plural forms including “at least one” as well, unless the context clearly indicates otherwise. A phrase “at least one” should not be construed as limited to be singular. “Or” means “and/or.” As used herein, the term “and/or” includes any and all combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s). It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value. Endpoints of ranges may each be independently selected.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments of inventive concepts are described herein with reference to cross-sectional views that schematically illustrates idealized embodiments. As such, variations from the shapes of the illustrations as a result, for example, of manufacturing techniques and/or tolerances, are to be expected. Thus, example embodiments of inventive concepts should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

“Group” means a group of the Periodic Table of the elements according to the International Union of Pure and Applied Chemistry (“IUPAC”) 1-18 Group classification system.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

A halide solid electrolyte may be added to a positive electrode of an all-solid-state battery to increase ionic conductivity and interfacial stability. However, when an electronically conductive material contained in a positive electrode and a solid electrolyte between the positive electrode and a negative electrode come into contact with each other, a decomposition reaction may occur on the surface of the halide solid electrolyte. Avoiding this decomposition reaction would be desirable.

Hereinafter, a positive electrode-solid electrolyte subassembly, and a method of preparing an electrochemical cell and the positive electrode-solid electrolyte assembly including the same will be described in more detail.

The positive electrode-solid electrolyte subassembly includes a positive electrode including a positive electrode active material, a conductive material, and a first solid electrolyte, a second solid electrolyte disposed on the positive electrode, and an interlayer disposed between the positive electrode and the second solid electrolyte, wherein the interlayer includes an interlayer material, the interlayer material having an electrical conductivity less than an electrical conductivity of the conductive material of the positive electrode, and wherein the first solid electrolyte contains lithium and a metal, and a sulfur-free lithium-ion conductor.

In an aspect, a sulfur content may be 0 mole percent to about 1 mole percent, about 0.0001 mole percent to about 1 mole percent, about 0.0001 mole percent to about 0.75 mole percent, about 0.001 mole percent to about 0.5 mole percent, or about 0.01 mole percent to about 0.1 mole percent, based on a total content of the sulfur-free lithium-ion conductor.

In an aspect, the first solid electrolyte may include a halide solid electrolyte represented by Formula 1.

In an aspect, the sulfur-free lithium-ion conductor may be sulfur-free.

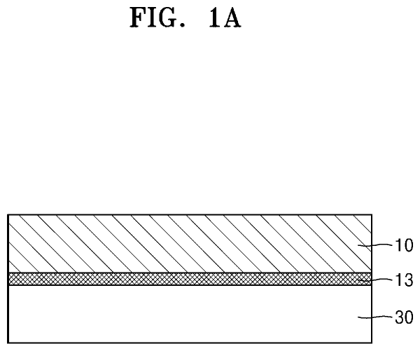

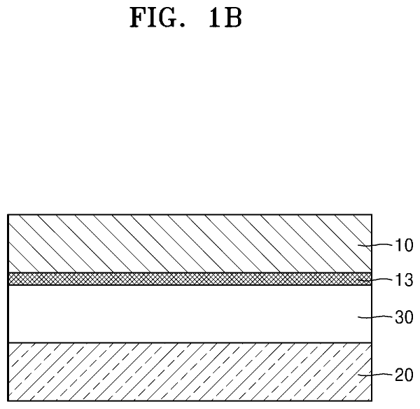

Referring to FIG. 1A, the positive electrode-solid electrolyte subassembly includes an interlayer 13 disposed between a positive electrode 10 including a first solid electrolyte, a conductive material, and a positive electrode active material, and a second solid electrolyte 30, the interlayer 13 containing an interlayer material having an electrical conductivity less than an electrical conductivity of the conductive material of the positive electrode.

The positive electrode 10 of the all-solid-state battery comprises the first solid electrolyte, the positive electrode active material and the conductive material. The first solid electrolyte of the positive electrode includes a halide solid electrolyte which is more excellent in stability than a sulfur-based (e.g., sulfide-based) solid electrolyte and may thus exhibit an excellent charge/discharge efficiency.

The halide solid electrolyte contains lithium, and a metal, and is a sulfur-free lithium-ion conductor compound (i.e., sulfur-free lithium-ion conductor). Additionally, the second solid electrolyte is disposed between the positive electrode and the negative electrode, and, for example, a sulfide-based (e.g., sulfide) solid electrolyte is used as the second solid electrolyte.

However, when the positive electrode containing the halide solid electrolyte and the conductive material is in direct contact with the sulfide-based solid electrolyte, which is the second solid electrolyte, a side reaction occurs between the positive electrode and the sulfide-based solid electrolyte. Although not limited theoretically, the side reaction is due to the fact that electrons (e-) in the sulfide-based solid electrolyte migrate to the positive electrode containing the conductive material having an excellent electronic conductivity, and a redox reaction is triggered to cause a decomposition reaction on the surface of the halide solid electrolyte.

To suppress the above-mentioned side reaction, the positive electrode-solid electrolyte subassembly according to an embodiment has a structure in which the interlayer containing the interlayer material having the electronic conductivity less than the conductive material of the positive electrode is placed between the positive electrode and the sulfide-based solid electrolyte. This structure prevents electron migration from the sulfide-based solid electrolyte to the positive electrode containing the halide solid electrolyte to suppress a side reaction between the positive electrode and the halide solid electrolyte, thereby suppressing a decomposition reaction occurred on a surface of the halide solid electrolyte. As a result, an electrochemical cell having the positive electrode-solid electrolyte subassembly may have improved charge/discharge efficiency without a decrease in energy density.

The interlayer material is a material having an electronic conductivity less than the electronic conductivity of the conductive material of the positive electrode as above described.

The conductive material of the positive electrode may be a carbon-based (e.g., carbon) material, and is, for example, graphite, carbon black, acetylene black, ketjen black, denka black, carbon fiber, carbon nanofiber, carbon nanotube, or a combination thereof.

The electronic conductivity of the conductive material of the positive electrode may be, for example, about 1 Siemen per meter (S/m), and thus the interlayer material has the electronic conductivity of less than 1 S/m, for example, about 1×10⁻¹ S/m to about 1×10⁻¹² S/m, about 1×10⁻² S/m to about 1×10⁻¹¹ S/m, or about 1×10⁻³ S/m to about 1×10⁻¹⁰ S/m. As illustrated in FIG. 1B, a negative electrode 20 is disposed on the other side of the second solid electrolyte 30, thus opposite the positive electrode 10, to obtain an electrochemical cell.

The first solid electrode contains lithium and the metal, and includes the sulfur (S)-free lithium-ion conductor compound. In addition, the first solid electrolyte may contain a phosphorus (P)-free lithium-ion conductor compound.

The interlayer material may include, for example, a metal sulfide, a metal oxide, a lithium metal oxide, a metal halide, a metal nitride, a metal carbonate, or a combination thereof.

The metal sulfide may be a sulfide containing, for example, copper (Cu), tin (Sn), cobalt (Co), nickel (Ni), zinc (Zn), titanium (Ti), cadmium (Cd), molybdenum (Mo), palladium (Pd), rhodium (Rh), zirconium (Zr), vanadium (V), hafnium (Hf), tungsten (W), aluminum (AI), or a combination thereof. The metal sulfide may be, for example, copper sulfide (CuS or Cu₂S), molybdenum disulfide (MoS₂), cadmium sulfide (CdS), zinc sulfide (ZnS), tungsten disulfide (WS₂), or a combination thereof. Among the metal sulfides, copper sulfide has an electronic conductivity of about 4×10⁻⁶ S/m.

The metal oxide may be zirconium dioxide (ZrO₂), aluminum oxide (Al₂O₃), silicon dioxide (SiO₂), zinc oxide (ZnO), zirconium oxide (ZrO₂), hafnium dioxide (HfO₂), titanium dioxide (TiO₂), tin dioxide (SnO₂), or a combination thereof. Zirconium dioxide has an electronic conductivity of about 6×10⁻⁷ S/m.

The lithium metal oxide may be lithium zirconium oxide, lithium titanium oxide or a combination thereof, and the lithium halide is lithium chloride, lithium fluoride, lithium bromide, lithium iodide, or a combination thereof. In addition, the metal carbonate may be lithium carbonate, magnesium carbonate, sodium carbonate, calcium carbonate, barium carbonate, or a combination thereof.

The metal nitride may be Li₃N, titanium nitride, tantalum nitride, molybdenum nitride, vanadium nitride, or a combination thereof.

The interlayer may have a thickness of, for example, about 1 nanometer (nm) to about 1000 nm (1 micrometer, μm), about 1 nm to about 800 nm, about 1 nm to about 500 nm, about 1 nm to about 300 nm, about 1 nm to about 200 nm, about 1 nm to about 100 nm, about 1 nm to about 80 nm, about 1 nm to about 50 nm, about 1 nm to about 30 nm, about 1 nm to about 20 nm, about 1 nm to about 15 nm, about 1 nm to about 10 nm, or about 1 nm to about 5 nm. When the thickness of the interlayer satisfies the aforementioned range, a side reaction between the first solid electrolyte of the positive electrode and the second solid electrolyte is suppressed, and thus an electrochemical cell having improved charge/discharge efficiency may be prepared.

The interlayer may contain, for example, copper sulfide or zirconium dioxide.

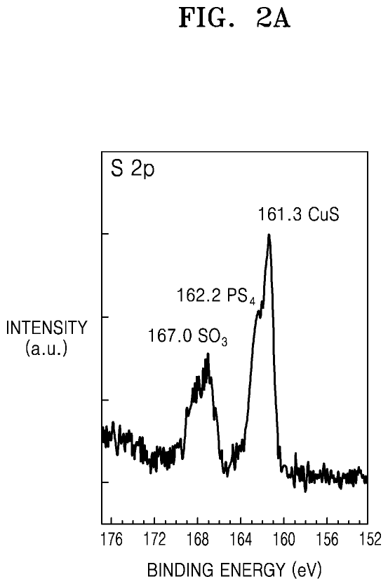

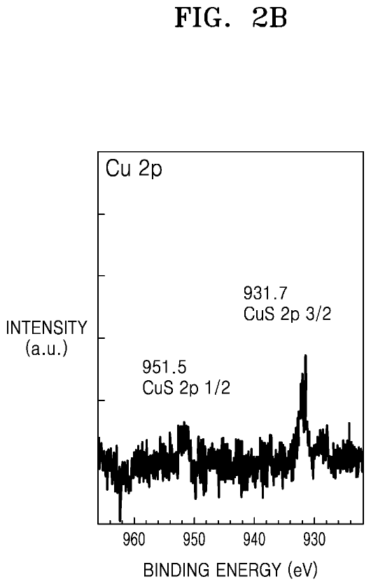

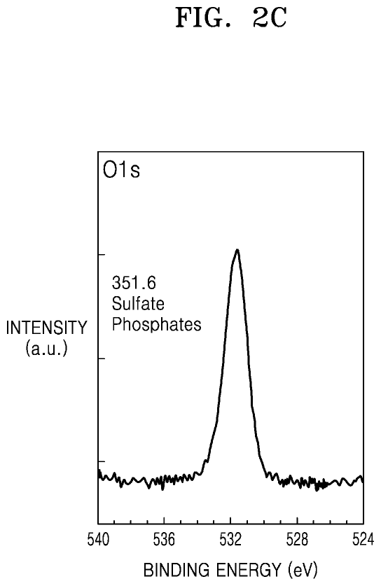

According to an embodiment, when the interlayer contains copper sulfide, the results of X-ray photoelectron spectroscopy (S2p) for the interlayer/solid electrolyte structure demonstrates that as shown in FIG. 2A, a first doublet peak appears at a range of binding energy of about 160 electronvolts (eV) to about 164 eV, measured by X-ray photoelectron spectroscopy (S2p) for sulfur (S) in the interlayer. In an aspect, when the interlayer is analyzed by X-ray photoelectron spectroscopy, the first doublet peak corresponding to an S2p peak of sulfur appears at a binding energy range of about 160 eV to about 164 eV, and the first doublet peak comprises a first peak at about 160 eV to about 162 eV and a second peak at about 162.1 eV to about 164 eV. Herein, the first peak is a CuS related peak, the second peak is a PS4 related peak, and the first peak has a greater intensity than the second peak.

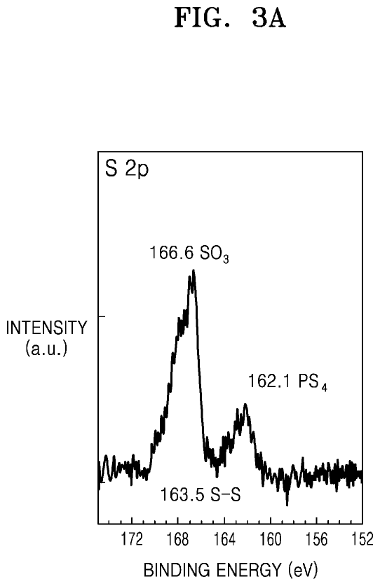

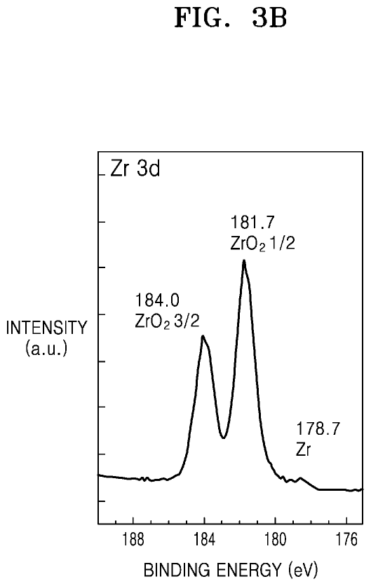

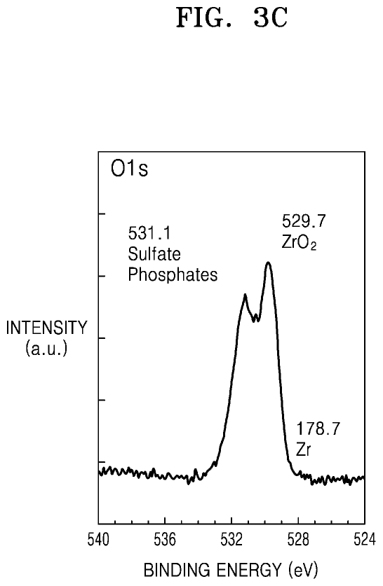

According to another embodiment, when the interlayer contains zirconium dioxide, the results of X-ray photoelectron spectroscopy (O1s) for the interlayer/solid electrolyte structure demonstrates that as shown in FIG. 3C, a second doublet peak appears at a binding energy range of about 528 eV to about 532 eV, as measured by X-ray photoelectron spectroscopy (O1s) for oxygen (O) in the interlayer. In an aspect, when the interlayer is analyzed by X-ray photoelectron spectroscopy, the second doublet peak corresponding to an O1 s peak of oxygen appears at a binding energy range of about 528 eV to about 532 eV, and the second doublet peak comprises a third peak at about 528 eV to about 530 eV and a fourth peak at about 530.1 eV to about 532 eV. The third peak is a ZrO₂ related peak, the fourth peak is a sulfate or phosphate related peak, and the third peak has a greater intensity than the fourth peak.

The first solid electrolyte contained in the positive electrode may contain a solid ion conductor compound represented by Formula 1:

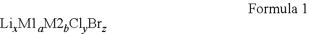

M1 includes an alkali metal, an alkaline earth metal, a transition metal, or a combination thereof; M2 is a lanthanide element, a non-lanthanide element having an oxidation number of 3, or a combination thereof; and 0<x<3.5, 0≤a<1.5, 0<b<1.5, 0≤y<6, 0≤z<6, 0<y+z≤6. It is excluded that y and z are 0 at the same time.

In Formula 1, M2 may be a lanthanide element of La, Ce, Pr, Nd, Pm, Sm, Eu, Gd, Tb, Dy, Ho, Er, Tm, Yb, Lu, or a combination thereof. Herein, M2 may be a lanthanide element having an oxidation number of 3.

M2, which is a non-lanthanide element having an oxidation number of 3, is Sc, Y, In, or a combination thereof. For example, M2 may be a lanthanide element of La, Ho, Tm, Yb, Lu, or a combination thereof, but is not limited thereto.

The solid ion conductor compound (e.g., lithium-ion conductor compound) of Formula 1 has a high ion conductivity, a low synthesis temperature, and a mechanical flexibility due to an anionic framework of a halogen having a large ionic radius. Particularly, when chlorine is contained as a halogen element, the lithium-ion conductor compound is stable even under an oxidation condition, and thus has low interfacial resistance.

According to an embodiment, in Formula 1, a pair of x and y may be, 2.5<x<3.5 and 2<y≤6, or 2.5<x<3.5 and 2<z≤6.

For example, in Formula 1, x may be 2.7<x<3.3, and x may be 3.

In Formula 1, y may be 6 and z may be 0, or y may be y=0 and z may be 6.

Since crystallization temperature is lowered by including the halogen element having a molar ratio satisfying the above range, synthesis at low temperature is facilitated, and ionic conductivity is increased due to increase in lattice sizes.

In Formula 1, a may be 0<a<1.5, and a part of Li may be substituted with M1. For example, M1 in Formula 1 may be placed at a lithium site in a crystal by doping. The introduction of M1 increases the volume of the crystal lattice, and reduces a migration resistance of a lithium ion, thereby improving the lithium-ion conductivity.

For example, in Formula 1, a may be 0<a≤1.4, 0<a≤1.3, 0<a≤1.2, 0<a<1.1, 0<a≤1, 0<a≤0.9, 0<a≤0.8, 0<a≤0.7, 0<a≤0.6, 0<a≤0.5, 0<a≤0.4, 0<a≤0.3, 0<a≤0.2 or 0<a≤0.1, but is not limited thereto. The range of a may be chosen in consideration of the charge balance of the compound without compromising the lithium-ion conductivity of the solid ion conductor compound, and for example, 0<a<0.1.

According to an embodiment, M1 may include Na, K, Rb, Cs, Fr, Be, Mg, Ca, Sr, Ba, Ra, Sc, Y, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, In, Ti, Ge, Sn, Pb, Sb, Bi, Po, or a combination thereof. When the metal element is included, the lithium-ion conductivity may be more improved by reducing migration resistance of a lithium ion in a crystal without collapse of the crystal.

According to an embodiment, in Formula 1, y and z may satisfy 1≤y≤5 and 1≤z≤5, respectively. Since crystallization temperature is lowered by including the halogen element having a molar ratio satisfying the above range, synthesis at low temperature is facilitated, and ionic conductivity is increased due to increase in lattice sizes.

According to an embodiment, in Formula 1, 2.5<x<3.5, 2<y<5, and 5.4<x+y<6.6 may be satisfied. For example, 2.7<x<3.3, 2.5<y<5, and 5.7<x+y<6.3 may be satisfied.

According to an embodiment, in Formula 1, b=1 may be satisfied.

According to an embodiment, in Formula 1, y=z may be satisfied. For example, y and z may be 3. When a molar fraction of Cl is the same as that of Br, activation energy may decrease due to lattice expansion of the solid ion conductor compound, and thus the lithium-ion conductivity may be significantly improved.

The solid ion conductor compound may include a crystal structure belonging to space groups of P3m1 and C2/m. Therefore, the solid ion conductor compound may have an excellent lithium-ion conductivity.

According to an embodiment, Formula 1 may be represented by Formula 2:

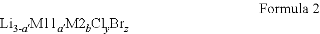

wherein, in Formula 2,
M11 is Na, K, Rb, Cs, Fr, Be, Mg, Ca, Sr, Ba, Ra, Sc, Y, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, In, Ti, Ge, Sn, Pb, Sb, Bi, Po, or a combination thereof,
M12 is La, Ce, Pr, Nd, Pm, Sm, Eu, Gd, Tb, Dy, Ho, Er, Tm, Yb, Lu, Sc, Y, In, or a combination thereof,
and 0≤a′<1.5, 0<b<1.5, 0≤y<6, 0≤z≤6, 0<y+z≤6. Thus, y and z are not 0 at the same time.

The first solid electrolyte may be represented by, for example, Formula 3:

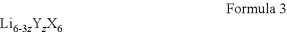

wherein, in Formula 3, 0<z<2, and X is Cl or Br.

Examples of the first solid electrolyte according to an embodiment include: LiₓHoCl_{y}(0<x<3.5, 0<y≤6), LiₓCeCl_{y} (0<x<3.5, 0<y≤6), LiₓPrCl_{y} (0<x<3.5, 0<y≤6), LiₓNdCl_{y} (0<x<3.5, 0<y≤6), LiₓPmCl_{y} (0<x<3.5, 0<y≤6), LiₓSmCl_{y} (0<x<3.5, 0<y≤6), LiₓEuCl_{y} (0<x<3.5, 0<y≤6), LiₓGdCl_{y} (0<x<3.5, 0<y≤6), LiₓTbCl_{y} (0<x<3.5, 0<y≤6, LiₓDyCl_{y} (0<x<3.5, 0<y≤6), LiₓErCl_{y} (0<x<3.5, 0<y≤6), LiₓTmCl_{y} (0<x<3.5, 0<y≤6), LiₓYbCl_{y} (0<x<3.5, 0<y≤6), LiₓInCl_{y}(0<x<3.5, 0<y≤6), LiₓYCl_{y} (0<x<3.5, 0<y≤6), and LiₓLuCl_{y} (0<x<3.5, 0<y≤6); LiₓM1ₐHoCl_{y} (0<x<3.5, 0≤a<1.5, 0<y≤6), LiₓM1ₐCeCl_{y} (0<x<3.5, 0≤a<1.5, 0<y≤6), LiₓM1ₐPrCl_{y} (0<x<3.5, 0≤a<1.5, 0<y≤6), LiₓM1ₐNdCl_{y} (0<x<3.5, 0≤a<1.5, 0<y≤6), LiₓM1ₐPmCl_{y} (0<x<3.5, 0≤a<1.5, 0<y≤6), LiₓM1ₐSmCl_{y} (0<x<3.5, 0≤a<1.5, 0<y≤6), LiₓM1ₐEuCl_{y} (0<x<3.5, 0≤a<1.5, 0<y≤6), LiₓM1ₐGdCl_{y} (0<x<3.5, 0≤a<1.5, 0<y≤6), LiₓM1ₐTbCl_{y} (0<x<3.5, 0≤a<1.5, 0<y≤6), LiₓM1ₐDyCl_{y} (0<x<3.5, 0≤a<1.5, 0<y≤6), LiₓM1ₐErCl_{y} (0<x<3.5, 0≤a<1.5, 0<y≤6), LiₓM1ₐTmCl_{y} (0<x<3.5, 0≤a<1.5, 0<y≤6), LiₓM1ₐYbCl_{y} (0<x<3.5, 0≤a<1.5, 0<y≤6), LiₓM1ₐnCl_{y} (0<x<3.5, 0≤a<1.5, 0<y≤6), LiₓM1ₐYCl_{y} (0<x<3.5, 0≤a<1.5, 0<y≤6), and LiₓM1ₐLuCl_{y} (0<x<3.5, 0≤a<1.5, 0<y≤6); LiₓHoBr_{z} (0<x<3.5, 0<z≤6), LiₓCeBr_{z} (0<x<3.5, 0<z≤6), LiₓPrBr_{z} (0<x<3.5, 0<z≤6), LiₓNdBr_{z} (0<x<3.5, 0<z≤6), LiₓPmBr_{z} (0<x<3.5, 0<z≤6), LiₓSmBr_{z} (0<x<3.5, 0<z≤6), LiₓEuBr_{z} (0<x<3.5, 0<z≤6), LiₓGdBr_{z} (0<x<3.5, 0<z≤6), LiₓTb Br_{z} (0<x<3.5, 0<z≤6), LiₓDy Br_{z} (0<x<3.5, 0<z≤6), LiₓErBr_{z} (0<x<3.5, 0<z≤6), LiₓTmBr_{z} (0<x<3.5, 0<z≤6), LiₓYbBr_{z} (0<x<3.5, 0<z≤6), LiₓlnBr_{y} (0<x<3.5, 0<y≤6), LiₓYBr_{y} (0<x<3.5, 0<y≤6), and LiₓLuBr_{z} (0<x<3.5, 0<z≤6);

LiₓM1ₐHoBr_{z} (0<x<3.5, 0≤a<1.5, 0<z≤6), LiₓM1ₐCeBr_{z} (0<x<3.5, 0≤a<1.5, 0<z≤6), LiₓM1ₐPrBr_{z} (0<x<3.5, 0≤a<1.5, 0<z≤6), LiₓM1ₐNdBr_{z} (0<x<3.5, 0≤a<1.5, 0<z≤6), LiₓM1ₐPmCl_{y} (0<x<3.5, 0≤a<1.5, 0<y≤6), LiₓM1ₐSmBr_{z} (0<x<3.5, 0≤a<1.5, 0<z≤6), LiₓM1ₐEuBr_{z} (0<x<3.5, 0≤a<1.5, 0<z≤6), LiₓM1ₐGdBr_{z} (0<x<3.5, 0≤a<1.5, 0<z≤6), LiₓM1ₐTbBr_{z} (0<x<3.5, 0≤a<1.5, 0<z≤6), LiₓM1ₐDyBr_{z} (0<x<3.5, 0≤a<1.5, 0<z≤6), LiₓM1ₐErBr_{z} (0<x<3.5, 0≤a<1.5, 0<z≤6), LiₓM1ₐTm (0<x<3.5, 0≤a<1.5, 0<y≤6), LiₓM1ₐYbBr_{z} (0<x<3.5, 0≤a<1.5, 0<z≤6), LiₓM1ₐlnBr_{z} (0<x<3.5, 0≤a<1.5, 0<z≤6), LiₓM1ₐYBr_{z} (0<x<3.5, 0≤a<1.5, 0<z≤6), and LiₓM1ₐLuBr_{z} (0<x<3.5, 0≤a<1.5, 0<z≤6); or a combination thereof, and
M1 may include an alkali metal, an alkaline earth metal, a transition metal, or a combination thereof.

The first solid electrolyte may contain, for example, Li₃lnCl6, Li₃YCl₆, Li₃YBr₆, Li₃LnCl6, Li₃LnBr₆, Li₃HOCl₆, Li₃HoBr₆, Li₃lnBr₆, Li₃YX₆ (where X is Cl, Br, or I), Li₃ErX₆ (where X is Cl, Br, or I), Li₃ScX₆ (where X is Cl, Br, or I), Li₃Lal₆, Li₃LuCl₆, Li₃₋ₓEr₁₋ₓZrₓCl₆ (where, 0<x≤0.6), Li₃₋ₓY₁₋ₓZrₓCl₆ (where 0<x≤0.6), Li₃Y₁₋ₓInₓCl₆ (where 0≤x<1), LiₓScCl₃₊ₓ(where 0≤x<5), or a combination thereof.

The first solid electrolyte according to an embodiment may be electrochemically stable with respect to a lithium metal in a potential window of, for example, about 0.6 V to about 4.2 V, about 1.0 V to about 4.2 V, about 1.5 V to about 4.2 V, about 2.0 V to about 4.2 V, or about 2.5 V to about 4.2 V. The solid electrolyte is electrochemically stable in wide voltage ranges, and is thus suitable for lithium batteries having various voltages.

A form of the first solid electrolyte is not particularly limited. For example, the first solid electrolyte may be in a particulate form, and may be a spherical particle or non-spherical particle. The particulate solid electrolyte may be molded into various forms. The molded solid electrolyte may be, for example, in the form of a sheet.

An ionic conductivity of the first solid electrolyte may be about 1×10⁻⁴ Siemens per centimeter (S/cm) or greater, about 1.8×10⁻⁴ S/cm or greater, about 1.9×10⁻⁴ S/cm or greater, about 2.0×10⁻⁴ S/cm or greater, about 2.5×10⁻⁴ S/cm or greater, about 3.0×10⁻⁴ S/cm or greater, about 3.5×10⁻⁴ S/cm or greater, about 4.0×10⁻⁴ S/cm or greater, about 4.5×10⁻⁴ S/cm or greater, about 5.0×10⁻⁴ S/cm or greater, about 5.5×10⁻⁴ S/cm or greater, or about 5.5×10⁻⁴ S/cm to about 5×10⁻³ S/cm at 20° C. Since the first solid electrolyte has an increased ionic conductivity in the range above, the first solid electrolyte may be used as an electrolyte of an electrochemical cell.

The second solid electrolyte is a sulfide-based (i.e., sulfide) solid electrolyte, an oxide-based (i.e., oxide) solid electrolyte, or a combination thereof.

The second solid electrolyte may include, for example, a compound having an argyrodite-type crystal structure and represented by Formula 4:

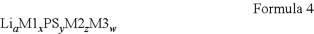

wherein, in Formula 4, M1 is a metal element, of Groups 1 to 15 of the Periodic Table, or a combination thereof, other than Li, M2 is an element of Group 17 of the Periodic Table, M3 is SOₙ, and 4≤a≤8, 0≤x<1, 3≤y≤7, 0<z≤2, 0≤w<2, and 1.5≤n≤5.

“Argyrodite” or “argyrodite-type” as used herein means that the compound has a crystal structure isostructural with argyrodite, Ag₈GeS₆.

In the compound represented by Formula 4, M1 may include, for example, Na, K, Mg, Ag, Cu, Hf, In, Ti, Pb, Sb, Fe, Zr, Zn, Cr, B, Sn, Ge, Si, Zr, Ta, Nb, V, Ga, Al, As, or a combination thereof. M1 may be, for example, a monovalent cation, or a divalent cation.

In the compound represented by Formula 4, M2 may include, for example, F, Cl, Br, I, or a combination thereof. M2 may be, for example, a monovalent anion.

In the compound represented by Formula 4, SOₙ of M3 may be, for example, S₄O₆, S₃O₆, S₂O₃, S₂O₄, S₂O₅, S₂O₆, S₂O₇, S₂O₈, SO₄, SO₅, or a combination thereof. SOₙ may be, for example, a divalent anion. SOₙ²⁻may be, for example, S₄O₆²⁻, S₃O₆²⁻, S₂O₃², S₂O₄²⁻, S₂O₅²⁻, S₂O₆²⁻, S₂O₇²⁻, S₂O₈², SO₄², SO₅²⁻, or a combination thereof.

The compound represented by Formula 4 may be, for example, a compound represented by Formula 5:

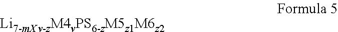

wherein, in Formula 5, M4 is Na, K, Mg, Ag, Cu, Hf, In, Ti, Pb, Sb, Fe, Zr, Zn, Cr, B, Sn, Ge, Si, Zr, Ta, Nb, V, Ga, Al, As, or a combination thereof, m is an oxidation number of M4, M5 and M6 are each independently, F, Cl, Br, or I, and 0<v<0.7, 0<z1<2, 0≤z2<1, 0<z<2, z=z1+z2 and 1≤m≤2.

For example, 0<v<0.7, 0<z1<2, 0≤z2≤0.5, 0<z<2, and z=z1+z2 may be satisfied. For example, 0<v<0.5, 0<z1<2, 0≤z2≤0.5, 0<z<2 and z=z1+z2 may be satisfied. For example, 0<v<0.1, 0<z1≤1.5, 0≤z2≤0.5, 0.5≤z1.8 and z=z1+z2 may be satisfied. For example, 0<v<0.05, 0≤z1≤1.5, 0≤z2≤0.5, 1.0≤z≤1.8 and z=z1+z2 may be satisfied. M4 may be, for example, a single metal element, or two kinds of metal elements.

A compound represented by Formula 5 may include, for example, a single halogen element or two kinds of halogen elements. In addition, the compound represented by Formula 3 may be a solid ion conductor compound represented by Formulas 5a to 5f:

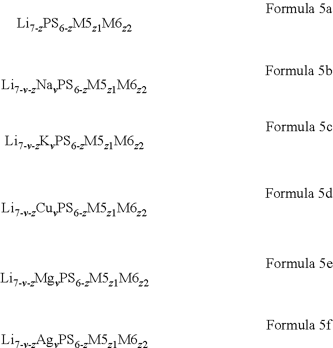

wherein, in the Formulas above, M5 and M6 are each independently F, Cl, Br, or I, and 0<v<0.7, 0<z1<2, 0≤z2<1, 0<z<2 and z=z1+z2 are satisfied. For example, 0<v≤0.5, 0<z1<2, 0≤z2≤0.5, 0<z<2 and z=z1+z2 may be satisfied. For example, 0<v≤0.3, 0<z1<1.5, 0≤z2≤0.5, 0.2≤z≤1.8 and z=z1+z2 may be satisfied. For example, 0<v≤0.05, 0<z1<1.5, 0≤z2≤0.2, 1.0≤z≤1.8 and z=z1+z2 may be satisfied.

Examples of the compound represented by Formula 5 include Li_{7-v-z}NaᵥPS_{6-z}F_{z1}, Li_{7-v-z}NaᵥPS_{6-z}Cl_{z1}, Li_{7-v-z}NaᵥPS_{6-z}Br_{z1}, Li_{7-v-z}NaᵥPS_{6-z}I_{z1}, Li_{7-v-z}NaᵥPS_{6-z}F_{z1}Cl_{z2}, Li_{7-v-z}NaᵥPS_{6-z}F_{z1}Br_{z2}, Li_{7-v-z}NaᵥPS_{6-z}F_{z1}I_{z2}, Li_{7-v-z}NaᵥPS_{6-z}Cl_{z1}Br_{z2}, Li_{7-v-z}NaᵥPS_{6-z}Cl_{z1}I_{z2} Li_{7-v-z}NaᵥPS_{6-z}Cl_{z1}F_{z2}, Li_{7-v-z}NaᵥPS_{6-z}Br_{z1}l_{z2}, Li_{7-v-z}NaᵥPS_{6-z}Br_{z1}F_{z2}, Li_{7-v-z}NaᵥPS_{6-z}Br_{z1}Cl_{z2}, Li_{7-v-z}NaᵥPS_{6-z}I_{z1}F_{z2}, Li_{7-v-z}NaᵥPS_{6-z}l_{z1}Cl_{z2}, Li_{7-v-z}NaᵥPS_{6-z}l_{z1}Br_{z2}, Li_{7-v-z} KᵥPS_{6-z}F_{z1}, Li_{7-v-z} KᵥPS_{6-z}Cl_{z1}, Li_{7-v-z} KᵥPS_{6-z}Br_{z1}, Li_{7-v-z} KᵥPS_{6-z}I_{z1}, Li_{7-v-z} KᵥPS_{6-z}F_{z1}Cl_{z2}, Li_{7-v-z} KᵥPS_{6-z}F_{z1}Br_{z2}, Li_{7-v-z}KᵥPS_{6-z}F_{z1}I_{z2}, Li_{7-v-z} KᵥPS_{6-z}Cl_{z1} Br_{z2}, Li_{7-v-z} KᵥPS_{6-z}Cl_{z1}I_{z2}, Li_{7-v-z} KᵥPS_{6-z}Cl_{z1}F_{z2}, Li_{7-v-z} KᵥPS_{6-z}Br_{z1}l_{z2} Li_{7-v-z} KᵥPS_{6-z}Br_{z1}F_{z2}, Li_{7-v-z} KᵥPS_{6-z}Br_{z1}Cl_{z2}, Li_{7-v-z} KᵥPS_{6-z}I_{z1}F_{z2}, Li_{7-v-z} KᵥPS_{6-z}l_{z1} Cl_{z2}, Li_{7-v-z} KᵥPS_{6-z}l_{z1} Br_{z2}, Li_{7-v-z}Cuᵥ PS_{6-z}F_{z1}, Li_{7-v-z}Cuᵥ PS_{6-z}Cl_{z1}, Li_{7-v-z}Cuᵥ PS_{6-z}Br_{z1}, Li_{7-v-z}Cuᵥ PS_{6-z}I_{z1}, Li_{7-v-z}Cuᵥ PS_{6-z}F_{z1}Cl_{z2}, Li_{7-v-z}Cuᵥ PS_{6-z}F_{z1} Br_{z2}, Li_{7-v-z}Cuᵥ PS_{6-z}F_{z1}l_{z2} Li_{7-v-z}Cuᵥ PS_{6-z}Cl_{z1}Br_{z2}, Li_{7-v-z}Cuᵥ PS_{6-z}Cl_{z1}l_{z2}, Li_{7-v-z}CuᵥPS_{6-z}Cl_{z1}F_{z2}, Li_{7-v-z}CuᵥPS_{6-z}Br_{z1}l_{z2}, Li_{7-v-z}Cuᵥ PS_{6-z}Br_{z1}F_{z2}, Li_{7-v-z}Cuᵥ PS_{6-z}Br_{z1}Cl_{z2}, Li_{7-v-z}CuᵥPS_{6-z}I_{z1}F_{z2}, Li_{7-v-z}CuᵥPS_{6-z}l_{z1} Cl_{z2}, Li_{7-v-z}Cuᵥ PS_{6-z}l_{z1} Br_{z2}, Li₇₋ᵥ₋MgᵥPS_{6-z}F_{z1}, Li₇₋ᵥ₋MgᵥPS_{6-z}Cl_{z1}, Li₇₋ᵥ₋MgᵥPS_{6-z}Br_{z1}, Li₇₋ᵥ₋MgᵥPS_{6-z}l_{z1}, Li₇₋ᵥ₋MgᵥPS_{6-z}F_{z1}Cl_{z2}, Li₇₋ᵥ₋MgᵥPS_{6-z}F_{z1}Br_{z2}, Li₇₋ᵥ₋MgᵥPS_{6-z}F_{z1}l_{z2} Li₇₋ᵥ₋MgᵥPS_{6-z}Cl_{z1} Br_{z2}, Li₇₋ᵥ₋MgᵥPS_{6-z}Cl_{z1}l_{z2} Li₇₋ᵥ₋MgᵥPS_{6-z}Cl_{z1}F_{z2}, Li₇₋ᵥ₋MgᵥPS_{6-z}Br_{z1}l_{z2} Li₇₋ᵥ₋MgᵥPS_{6-z}Br_{z1}F_{z2}, Li₇₋ᵥ₋MgᵥPS_{6-z}Br_{z1}Cl_{z2}, Li₇₋ᵥ₋MgᵥPS_{6-z}I_{z1}F_{z2}, Li₇₋ᵥ₋MgᵥPS_{6-z}l_{z1}Cl_{z2}, Li₇₋ᵥ₋MgᵥPS_{6-z}l_{z1}Br_{z2}, Li_{7-v-z}AgᵥPS_{6-z}F_{z1}, Li_{7-v-z}AgᵥPS_{6-z}Cl_{z1}, Li_{7-v-z}AgᵥPS_{6-z}Br_{z1}, Li_{7-v-z}AgᵥPS_{6-z}I_{z1}, Li_{7-v-z}AgᵥPS_{6-z}F_{z1}Cl_{z2}, Li_{7-v-z}AgᵥPS_{6-z}F_{z1}Br_{z2}, Li_{7-v-z}AgᵥPS_{6-z}F_{z1}l_{z2} Li_{7-v-z}AgᵥPS_{6-z}Cl_{z1} Br_{z2}, Li_{7-v-z}AgᵥPS_{6-z}Cl_{z1}l_{z2} Li_{7-v-z}AgᵥPS_{6-z}Cl_{z1}F_{z2}, Li_{7-v-z}AgᵥPS_{6-z}Br_{z1}l_{z2} Li_{7-v-z}AgᵥPS_{6-z}Br_{z1}F_{z2}, Li_{7-v-z}AgᵥPS_{6-z}Br_{z1}Cl_{z2}, Li_{7-v-z}AgᵥPS_{6-z}I_{z1}F_{z2}, Li_{7-v-z}AgᵥPS_{6-z}l_{z1}Cl_{z2}, Li_{7-v-z}AgᵥPS_{6-z}l_{z1}Br_{z2}, or a combination thereof. In the Formulas above, 0<v<0.7, 0<z1<2, 0<z2<1, 0<z<2 and z=z1+z2 may be satisfied. For example, 0<v<0.7, 0<z1<2, 0<z2≤0.5, 0<z<2, and z=z1+z2 may be satisfied. For example, 0<v≤0.3, 0<z1<1.5, 0<z2≤0.5, 0.2≤z≤1.8 and z=z1+z2 may be satisfied. For example, 0<v≤0.1, 0<z1<1.5, 0<z2≤0.5, 0.2≤z≤1.8 and z=z1+z2 may be satisfied. For example, 0<v≤0.05, 0<z1<1.5, 0<z2≤0.2, 1.0≤z≤1.8 and z=z1+z2 may be satisfied.

The sulfide-based solid electrolyte may be, for example, Li₆PS₅Cl, Li₆PS₅Br, Li₆PS₅₁, or a combination thereof.

The second solid electrolyte is, for example, a sulfide-based solid electrolyte of Li₂S—P₂S₅, Li₂S—P₂S₅—LiX, in which X is a halogen element, Li₂S—P₂S₅—Li₂O, Li₂S—P₂S₅-Li₂O-Lil, Li₂S-SiS₂, Li₂S-SiS₂—Lil, Li₂S-SiS₂—LiBr, Li₂S-SiS₂—LiCl, Li₂S-SiS₂—B₂S₃—Lil, Li₂S-SiS₂—P₂S₅—Lil, Li₂S-B₂S₃, Li₂S—P₂S₅—ZₘSₙ, in which m and n are positive numbers, and Z is one among Ge, Zn, or Ga, Li₂S-GeS₂, Li₂S-SiS₂—Li₃PO₄, Li₂S-SiS₂—LiₚMO_{q}, in which p and q are positive numbers, and M is one among P, Si, Ge, B, Al, Ga, and In, Li₇₋ₓPS₆₋ₓClₓ (0<x<2), Li₇₋ₓPS₆₋ₓBrₓ (0<x<2), Li₇₋ₓPS₆₋ₓlₓ (0<x<2), or a combination thereof.

An ionic conductivity of the second solid electrolyte may be about 1×10⁻³ S/cm or greater, about 2×10⁻³ S/cm or greater, about 3×10⁻³ S/cm or greater, or about 4×10⁻³ S/cm or greater at 20° C. An ionic conductivity of the second solid electrolyte may be about 1×10⁻³ S/cm to about 1×10−¹S/cm, about 1×10⁻³ S/cm to about 1×10−²S/cm, about 1×10⁻³ S/cm to about 8×10⁻³ S/cm, or about 1×10⁻³ S/cm to about 5×10⁻³ S/cm at 25° C. The second solid electrolyte has increased ionic conductivity in the range above, and may thus be used as an electrolyte of an electrochemical cell.

The solid electrolyte may be, for example, an oxide-based solid electrolyte. The oxide-based solid electrolyte may be Li₁+x+_{y}AlₓTi₂₋ₓSi_{y}P_{3-Y}O₁₂ (0<x<2, 0≤y<3), Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(AlₚGa₁₋ₚ)ₓ(Ti_{q}Ge_{1-q})₂₋ₓSi_{y}P_{3-y}O₁₂ (0≤x≤1, 0≤y≤1, 0≤p≤1, and 0≤q≤1), LiₓLa_{y}TiO₃ (0<x<2, 0<y<3), Li₂O, LiOH, Li₂CO₃, LiAIO₂, Li₂O—Al₂O₃—SiO₂—P₂O₅—TiO₂—GeO₂, Li₃₊ₓLa₃M₂O₁₂ (M is Te, Nb, or Zr, and x is an integer of 1 to 10), or a combination thereof. The solid electrolyte may be manufactured by a sintering method, etc.

The oxide-based solid electrolyte is, for example, a garnet-type solid electrolyte.

The garnet-type solid electrolyte may be, as a non-limiting example, an oxide represented by Formula 6:

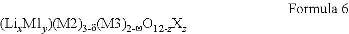

wherein, in Formula 6, 3≤x≤8, 0≤y<2, −0.2≤ō≤0.2, −0.2≤ω≤0.2, 0≤z≤2 are satisfied, M1 is a monovalent cation, a divalent cation, a trivalent cation, or a combination thereof, M2 is a monovalent cation, a divalent cation, a trivalent cation, or a combination thereof, M3 is a monovalent cation, a divalent cation, a trivalent cation, a tetravalent cation, a pentavalent cation, a hexavalent cation, or a combination thereof, and X is a monovalent anion, a divalent anion, a trivalent anion, or a combination thereof.

In Formula 6, examples of the monovalent cation include Na, K, Rb, Cs, H, Fr, etc., and examples of the divalent cation include Mg, Ca, Ba, Sr, etc. Examples of the trivalent cation include In, Sc, Cr, Au, B, Al, Ga, etc., and examples of the tetravalent cation include Sn, Ti, Mn, Ir, Ru, Pd, Mo, Hf, Ge, V, Si, etc. Additionally, examples of a pentavalent cation include Nb, Ta, Sb, V, P, etc.

M1 is, for example, hydrogen (H), iron (Fe), gallium (Ga), aluminum (AI), boron (B), beryllium (Be), or a combination thereof. M2 is lanthanum (La), barium (Ba), calcium (Ca), strontium (Sr), yttrium (Y), bismuth (Bi), praseodymium (Pr), neodymium (Nd), actinium (Ac), samarium (Sm), gadolinium (Gd) or a combination thereof, and M3 is zirconium (Zr), hafnium (Hf), tin (Sn), niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), thallium (TI), platinum (Pt), silicon (Si), aluminum (AI), or a combination thereof.

In Formula 6, the monovalent anion used as X is a halogen atom, a pseudohalogen, or a combination thereof, the divalent anion is S²⁻or Se²⁻, and the trivalent anion is, for example, N³⁻.

In Formula 6, x may be 3≤x≤8, 4≤x≤8, 5≤x≤8, 6≤x≤8, 6.6≤x≤8, 6.7≤x≤7.5, or 6.8≤x≤7.1.

Non-limiting examples of the garnet-based solid electrolyte may include an oxide represented by Formula 7:

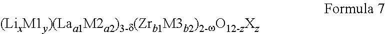

wherein, in Formula 7, M1 is hydrogen (H), iron (Fe), gallium (Ga), aluminum (AI), boron (B), beryllium (Be) or a combination thereof, M2 is barium (Ba), calcium (Ca), strontium (Sr), yttrium (Y), bismuth (Bi), praseodymium (Pr), neodymium (Nd), actinium (Ac), samarium (Sm), gadolinium (Gd), or a combination thereof, M3 is hafnium (Hf), tin (Sn), tin (Sn), niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), thallium (TI), platinum (Pt), silicon (Si), aluminum (AI), or a combination thereof, 3≤x≤8, 0≤y<2,-ō0.25550.2,-0.2ω≤0.2, 0≤z≤2, a1+a2=1, 0<a1<1, 0≤a2<1, b1+b2=1, 0<b1<1, 0≤b2<1, and X is a monovalent anion, a divalent anion, a trivalent anion, or a combination thereof.

In Formula 7, the monovalent anion used as X is a halogen atom, a pseudohalogen, or a combination thereof, the divalent anion is S²⁻or Se²⁻, and the trivalent anion is, for example, N³⁻. In Formula 7, 3≤x≤8, 4≤x≤8, 5≤x≤8, 6≤x≤8, 6.6≤x≤8, 6.7≤x≤7.5, or 6.8≤x≤7.1 may be satisfied.

As used herein, a “pseudohalogen” is a molecule consisting of at least two electronegative atoms which resemble halogens in the free state and have electronegativities, and produces anions similar to halide ions. Examples of the pseudohalogen include a cyanide, a cyanate, a thiocyanate, an azide, or a combination thereof. A halogen atom is, for example, iodine (I), chlorine (Cl), bromine (Br), fluorine (F), or a combination thereof, and a pseudohalogen is, for example, a cyanide, a cyanate, a thiocyanate, an azide, or a combination thereof. In addition, a trivalent anion is, for example, N³⁻.

In Formula 7, M3 may be Al, Ga, In, Si, Ge, Sn, Sb, Bi, Sc, Y, Ti, Hf, V, Nb, Ta, W, or a combination thereof.

According to another embodiment, the garnet-type solid electrolyte may be an oxide represented by Formula 8:

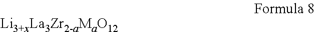

wherein, in Formula 8, M is Al, Ga, In, Si, Ge, Sn, Sb, Bi, Sc, Y, Ti, Hf, V, Nb, Ta, W, a combination thereof, x is a number of 1 to 10, and 0≤a<2.

Examples of the garnet-type solid electrolyte may include Li₇La₃Zr₂O₁₂, Li_{6.5}La₃Zr_{1.5}Ta_{0.5}O₁₂, etc.

### Electrochemical Cell

An electrochemical cell according to another embodiment includes a positive electrode-solid electrolyte subassembly, and a negative electrode. The electrochemical cell includes the above-mentioned subassembly, and thus has improved charge/discharge efficiency.

The electrochemical cell is, for example, an all-solid-state secondary battery.

Hereinafter, the all-solid-state secondary battery will be described in more detail.

### All-Solid-State Secondary Battery: First Type

A first type of an all-solid-state secondary battery is an all-solid-state battery having a non-precipitated-type negative electrode.

The all-solid-state secondary battery may include a positive electrode-solid electrolyte subassembly according to an embodiment.

The all-solid-state secondary battery includes, for example, the aforementioned positive electrode-solid electrolyte subassembly and the negative electrode, and a solid electrolyte of the positive electrode-solid electrolyte subassembly is disposed between the positive electrode and the negative electrode.

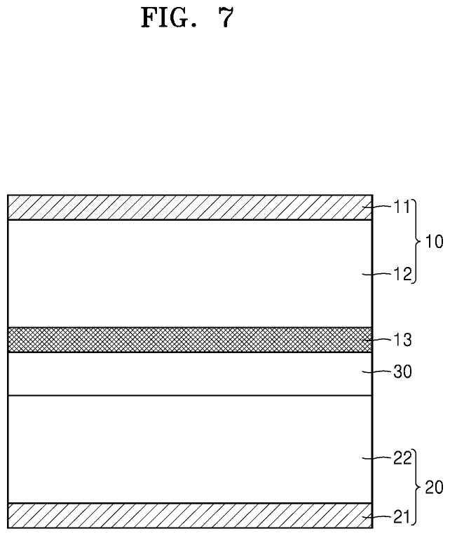

FIG. 7 is a schematic view of an all-solid-state battery including a non-precipitated-type negative electrode according to an embodiment. In the all-solid-state battery including a non-precipitated-type negative electrode, an initial charge capacity of a negative electrode active material layer at the time of initial charging is, for example, greater than about 50%, at least about 60%, at least about 70%, at least about 80%, at least about 90%, or at least about 100% of an initial charge capacity of a positive electrode active material layer.

A second solid electrolyte 30 of the positive electrode-solid electrolyte subassembly is disposed between a positive electrode 10 and a negative electrode 20, and an interlayer 13 is disposed between the positive electrode 10 and the second solid electrolyte 30.

The second solid electrolyte may be an oxide-based solid electrolyte, a sulfide-based solid electrolyte, or a combination thereof.

The solid electrolyte 30 further includes, for example, a binder. The binder included in the solid electrolyte 30 is, for example, styrene butadiene rubber (SBR), polytetrafluoroethylene, polyvinylidene fluoride, polyethylene, etc., but is not limited thereto. Any suitable binder available in the related technical art, may be used. The binder in the solid electrolyte 30 may be the same as, or different from a binder in a positive electrode active material layer 12 and a negative electrode active material layer 22.

The positive electrode includes a positive electrode active material, a first solid electrolyte and a conductive material. The positive electrode may further include an additive such as a binder, a filler, a dispersant, or an ionic conductive aid. The binder is, for example, styrene butadiene rubber (SBR), polytetrafluoroethylene, polyvinylidene fluoride, polyethylene, etc. A known material generally used in an electrode of a solid-state secondary battery is used as a coating agent, a dispersant, an ionic conductive aid, etc., which may be mixed into the positive electrode 10.

A first solid electrolyte contained in the positive electrode 10 is a sulfide-based solid electrolyte, an oxide-based solid electrolyte, or a combination thereof.

The positive electrode 10 may be further impregnated with a liquid electrolyte. The liquid electrolyte may include a lithium salt and an ionic liquid, a polymer ionic liquid, or a combination thereof. The liquid electrolyte may be non-volatile. The ionic liquid refers to a salt in a liquid state at a room temperature or a molten salt at a room temperature, which has a melting point of a room temperature or less and is composed solely of ions. The ionic liquid comprises: a) a cation of ammonium-based cation, pyrrolidinium-based cation, pyridinium-based cation, pyrimidine-based cation, imidazolium-based cation, piperidinium-based cation, pyrazolium-based cation, oxazolium-based cation, pyridazinium-based cation, phosphonium-based cation, sulfonium-based cation, triazolium-based cation, or a mixture thereof; and b) an anion of BF₄₋, PF₆₋, AsF₆₋, SbF₆₋, AICl₄₋, HSO₄₋, ClO₄₋, CH₃SO₃₋, CF₃CO₂₋, Cl-, Br-, l-, SO₄²⁻, CF₃SO₃₋, (FSO₂)_{2N-}, (C₂F₅SO₂)_{2N-}, (C₂F₅SO₂)(CF₃SO₂)N-, (CF₃SO₂)₂N-, or a combination thereof. The ionic liquid is, for example, N-methyl-N-propylpyrrolidinium bis(trifluoromethanesulfonyl)imide, N-butyl-N-methylpyrrolidium bis(3—trifluoromethylsulfonyl)imide, 1—butyl-3-methylimidazolium bis(trifluoromethylsulfonyl)imide and 1—ethyl-3—methylimidazolium bis(trifluoromethylsulfonyl)amide. The polymer ionic liquid may contain a repeating unit including: a) a cation of ammonium-based cation, pyrrolidinium-based cation, pyridinium-based cation, pyrimidinium-based cation, imidazolium-based cation, piperidinium-based cation, pyrazolium-based cation, oxazolium-based cation, pyridazinium-based cation, phosphonium-based cation, sulfonium-based cation, triazolium-based cation, or a mixture thereof; and b) an anion of BF₄₋, PF⁶⁻, AsF₆₋, SbF₆₋, AICl₄₋, HSO₄₋, ClO₄₋, CH₃SO₃₋, CF₃CO₂₋, (CF₃SO₂)₂N-, (FSO₂)₂N-, Cl-, Br-, l-, SO₄²⁻, CF₃SO₃₋, (C₂F₅SO₂)₂N-, (C₂F₅SO₂)(CF₃SO₂)N-, NO₃₋, Al₂Cl₇₋, (CF₃SO₂)₃C-, (CF₃)₂PF₄₋, (CF₃)₃PF₃₋, (CF₃)₄PF₂₋, (CF₃)₅PF-, (CF₃)₆P-, SF₅CF₂SO₃—, SF₅CHFCF₂SO₃₋, CF₃CF₂(CF₃)₂CO-, CF₃SO₂)₂CH-, (SF₅)₃C-, (O(CF₃)₂C₂, (CF₃)₂O)₂PO-, or a combination thereof. Any suitable lithium salt available in the related technical art as a lithium salt may be used. The lithium salt is, for example, LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAIO₂, LiAICl₄, LiN(CₓF₂ₓ₊₁ SO₂)(C_{y}F_{2y+1}SO₂) (where, x and y are natural numbers), LiCl, Lil, or a combination thereof. A concentration of the lithium salt included in the liquid electrolyte may be about 0.1 molar (M) to about 5 M. An amount of the liquid electrolyte with which the positive electrode 10 is impregnated is 100 parts by weight or less, about 0.1 part by weight to about 50 parts by weight, about 0.1 part by weight to about 30 parts by weight, about 0.1 part by weight to about 20 parts by weight, about 0.1 part by weight to about 10 parts by weight, about 0.1 part by weight to about 5 parts by weight, about 0.2 part by weight to about 5 parts by weight, or about 0.3 part by weight to about 5 parts by weight, with respect to 100 parts by weight of the positive electrode active material layer 12 which does not include a liquid electrolyte.

The positive electrode 10 may be prepared by forming, on a current collector, a positive electrode active material layer including a positive electrode active material. The positive electrode active material may have an average particle diameter of, for example, about 2 μm to about 10 μm. The average particle diameter is a median particle diameter (D50) as measured using, for example, a laser scattering particle size distribution analyzer.

Any suitable positive electrode active material typically used in a secondary battery may be used without limitation. For example, the positive electrode active material may be a lithium transition metal oxide, a transition metal sulfide, etc. For example, a composite oxide of lithium, a metal of cobalt, manganese, nickel, or a combination thereof may, be used as the positive electrode active material, and specific examples of the positive electrode active material include a compound represented by any of: LiaA_{1-b}B¹_{b}D¹₂ (where, 0.90≤a<1.8, and 0≤b≤0.5 are satisfied.); LiₐE_{1-b}B¹_{b}O_{2-c}D¹_{c} (where, 0.90≤a≤1.8, 0<b≤0.5, 0<c≤0.05 are satisfied.); LiE_{2-b}B¹_{b}O_{4-c}D¹_{c} (where, 0≤b≤0.5, 0≤c≤0.05 are satisfied.); LiₐNi_{1-b-c}Co_{b}B¹_{c}D¹_{α} (where, 0.90≤a≤1.8, 0<b≤0.5, 0≤c≤0.05, 0<a≤2 are satisfied.); LiₐNi_{1-b-c}Co_{b}B¹_{c}O₂₋ₐF¹_{α} (where, 0.90≤a≤1.8, 0≤b≤0.5, 0≤c≤0.05, 0<α<2 are satisfied); LiₐNi_{1-b-c}Co_{b}B¹_{c}O₂₋ₐF¹_{α} (where, 0.90≤a≤1.8, 0≤b≤0.5, 0≤c≤0.05, 0<α<2 are satisfied.); LiₐNi_{1-b-c}Mn_{b}B¹_{c}D¹_{α} (where, 0.90≤a≤1.8, 0≤b≤0.5, 0≤c≤0.05, 0<α<2 are satisfied.); LiₐNi_{1-b-c}Mn_{b}B¹_{c}O₂₋ₐF¹_{α} (where, 0.90≤a≤1.8, 0≤b≤0.5, 0≤c≤0.05, 0<α<2 are satisfied.); LiₐNi_{1-b-c}Mn_{b}B¹_{c}O₂₋ₐF¹₂ (where, 0.90≤a≤1.8, 0≤b≤0.5, 0≤c≤0.05, 0<α<2 are satisfied.); and LiₐNi_{b}E_{c}G_{d}O₂ (where, 0.90≤a≤1.8, 0≤b≤0.9, 0≤c≤0.5, 0.001≤d≤0.1 are satisfied.); LiₐNi_{b}Co_{c}Mn_{d}GₑO₂ (where, 0.90≤a≤1.8, 0≤b≤0.9, 0≤c≤0.5, 0≤d≤0.5, 0.001≤e≤0.1 are satisfied); LiₐNiG_{b}O₂ (where, 0.90≤a≤1.8, 0.001≤b≤0.1 are satisfied); LiₐCoG_{b}O₂ (where, 0.90≤a≤1.8, 0.001≤b≤0.1 are satisfied); LiₐMnG_{b}O₂ (where, 0.90≤a≤1.8, 0.001≤b≤0.1 are satisfied); LiₐMn₂G_{b}O₄ (where, 0.90≤a≤1.8, 0.001≤b≤0.1 are satisfied); QO₂; QS₂; LiQS₂; V₂O₅; LiV₂O₅; Lil¹O₂; LiNiVO₄; Li_{(3-f)}J₂(PO₄)₃ (0≤f≤2); Li_{(3-f)}Fe₂(PO₄)₃ (0≤f≤2); LiFePO₄, or a combination thereof. In the Formulas above, A is Ni, Co, Mn, or a combination thereof; B¹ is Al, Ni, Co, Mn, Cr, Fe, Mg, Sr, V, a rare earth element, or a combination thereof; D¹ is O, F, S, P, or a combination thereof; E is Co, Mn, or a combination thereof; F¹ is F, S, P, or a combination thereof; G is Al, Cr, Mn, Fe, Mg, La, Ce, Sr, V, or a combination thereof; Q is Ti, Mo, Mn, or a combination thereof; l¹ is Cr, V, Fe, Sc, Y, or a combination thereof; and J is V, Cr, Mn, Co, Ni, Cu, or a combination thereof. Examples of the positive electrode active material include LiCoO₂, LiMnₓO₂ₓ (x is 1 or 2), LiNi₁₋ₓMnₓO₂ₓ(0<x<1), Ni_{1-x-y}CoₓMn_{y}O₂ (O≤x≤0.5, 0≤y≤0.5), Ni_{1-x-y}CoₓAl_{y}O₂ (O≤x≤0.5, 0≤y≤0.5), LiFePO₄, TiS₂, FeS₂, TiS₃, FeS₃, etc.

A compound added with a coating layer on the surface of such a compound may be used, and a mixture of the aforementioned compound and the compound added with the coating layer may also be used. The coating layer added to the surface of the compound includes, for example, a coating element compound, which is an oxide or a hydroxide of a coating element, an oxyhydroxide of the coating element, an oxycarbonate of the coating element, or a hydroxycarbonate of the coating element. A compound of the coating layer is amorphous or crystalline. The coating element included in the coating layer is Mg, Al, Co, K, Na, Ca, Si, Ti, V, Sn, Ge, Ga, B, As, Zr, or a mixture thereof. A forming method of the coating layer is selected unless the physical properties of the positive electrode active material are adversely affected. A coating method is, for example, a spray coating method, a dipping method, etc. A specific coating method is well understood by those skilled in the art, and thus detailed description thereof will be omitted.

The positive electrode active material includes, for example, a lithium salt of a transition metal oxide having a layered rock salt type structure among the aforementioned lithium transition metal oxides. The “layered rock salt type” structure is a structure in which an oxygen atom layer and a metal atom layer are alternatively and regularly arranged in the direction of <111> of a cubic rock salt type structure, and thus each atomic layer forms a two-dimensional plane. The “cubic rock salt type structure” represents a NaCl type structure, which is one type of a crystal structure, and specifically represents a structure where face centered cubic lattices (FCCs) formed by cations and anions, are shifted by ½ of the ridge of the unit lattice. The lithium transition metal oxide having such a layered rock salt type structure is, for example, a ternary lithium transition metal oxide such as LiNiₓCo_{y}Al_{z}O₂ (NCA), or LiNiₓCo_{y}Mn_{z}O₂ (NCM) (0<x<1, 0<y<1, 0<z<1, x+y+z=1 are satisfied). When the positive electrode active material includes the ternary lithium transition metal oxide having a layered rock salt type structure, an all-solid-state secondary battery 1 has more improved energy density and thermal stability.

The positive electrode active material may be covered by a cladding layer as described above. Any cladding layer known as a cladding layer of the positive electrode active material of an all-solid-state secondary battery may be used. The cladding layer is, for example, Li₂O-ZrO₂ (LZO), etc.

When the positive electrode active material includes, for example, nickel (Ni) as a ternary lithium transition metal oxide such as NCA or NCM, a metal elution of the positive electrode active material may be reduced in a charged state by increasing a capacity density of the all-solid-state secondary battery. As a result, the all-solid-state secondary battery has improved cycle characteristics in the charged state.

A shape of the positive electrode active material is, for example, a particle shape such as a sphere shape, and an ellipse shape. A particle diameter of the positive electrode active material is not particularly limited, and is in a range applicable to a positive electrode active material of a conventional all-solid-state secondary battery. An amount of the positive electrode active material of a positive electrode layer is also not particularly limited, and is in a range applicable to a positive electrode layer of an all-solid-state secondary battery. The amount of the positive electrode active material in the positive electrode active material layer may be, for example, about 50 weight percent (wt %) to about 95 wt %.

A suitable material generally used in an electrode of an all-solid-state secondary battery may be used as a filler, a coating agent, a dispersant, an ionic conductive aid, which may be included in the positive electrode active material layer.

As a positive electrode current collector, for example, a plate, a foil, or the like, which is formed by aluminum (AI), indium (In), copper (Cu), magnesium (Mg), stainless steel, titanium (Ti), iron (Fe), cobalt (Co), nickel (Ni), zinc (Zn), germanium (Ge), lithium (Li) or an alloy thereof is used. The positive electrode current collector may be omitted.

In an embodiment, the positive electrode current collector 11 may include, for example, a base film and a metal layer disposed on one side or both sides of the base film. The base film may include, for example, a polymer. The polymer may be, for example, a thermoplastic polymer. The polymer may include, for example, polyethylene terephthalate (PET), polyethylene (PE), polypropylene (PP), polybutylene terephthalate (PBT), polyimide (PI), or a combination thereof. Sine the base film includes thermoplastic polymers, the base film may liquefy in an event of a short-circuit, thus the rapid increase in current may be suppressed. The base film may be, for example, an insulator. The metal layer may include, for example, indium (In), copper (Cu), magnesium (Mg), stainless steel, titanium (Ti), iron (Fe), cobalt (Co), nickel (Ni), zinc (Zn), aluminum (Al), germanium (Ge), or an alloy thereof. The positive electrode current collector 11 may additionally include a metal chip and/or a lead tab. Specific descriptions of the base film, the metal layer, the metal chip and the lead tab of the positive electrode current collector 11 refer to descriptions of a negative electrode current collector 21 to be described later. A weight of the electrode may be reduced by having such structure of the positive electrode current collector 11 and, as a result, the energy density may be improved.

The negative electrode may be prepared in the same manner as the positive electrode except for using a negative electrode active material in place of the positive electrode active material. The negative electrode may be prepared by forming a negative electrode active material layer including a negative electrode active material on a negative electrode current collector.

The negative electrode active material may be a lithium metal, a lithium metal alloy, or a combination thereof.

The negative electrode active material layer may further include a conventional negative electrode active material in addition to the lithium metal, the lithium metal alloy, or a combination thereof. The typical negative electrode active material may include, for example, a metal that may be alloyed with lithium, a transition metal oxide, a non-transition metal oxide, a carbon-based material, or a combination thereof. The metal that may be alloyed with lithium may be, for example, Ag, Si, Sn, Al, Ge, Pb, Bi, Sb-Si—Y alloy (where Y is an alkali metal, an alkaline earth metal, an element in Group 13, an element in Group 14, a transition metal, a rare earth element, or a combination thereof, and Si is excluded), Sn—Y alloy (where Y is an alkali metal, an alkaline earth metal, an element in Group 13, an element in Group 14, a transition metal, a rare earth element or a combination thereof, and Sn is excluded), etc. The element Y may be Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof. The transition metal oxide may be, for example, lithium titanium oxide, vanadium oxide, lithium vanadium oxide, etc. Non-transition metal oxide may be, for example, SnO₂, SiOₓ (₀<x<2), etc. The carbon-based material may be, for example, a crystalline carbon, an amorphous carbon, or a mixture thereof. The crystalline carbon may be graphite such as natural graphite, or artificial graphite, each of which has an arbitrary shape, a plate shape, a flake shape, a spherical shape, or a fiber shape, and the amorphous carbon may be soft carbon (low-temperature calcined carbon), hard carbon, mesophase pitch carbide, calcined coke, etc.

The negative electrode current collector 21 may include, for example, a base film and a metal layer disposed on one side or both sides of the base film. The base film may include, for example, a polymer. The polymer may be, for example, a thermoplastic polymer. The polymer may include, for example, polyethylene terephthalate (PET), polyethylene (PE), polypropylene (PP), polybutylene terephthalate (PBT), polyimide (PI), or a combination thereof. Since the base film includes thermoplastic polymers, the base film may liquefy in an event of a short-circuit, and thus the rapid increase in current may be suppressed. The base film may be, for example, an insulator. The metal layer may include, for example, copper (Cu), stainless steel, titanium (Ti), iron (Fe), cobalt (Co), nickel (Ni), or an alloy thereof. The metal layer may act as an electrochemical fuse to be cut off in the event of an overcurrent, and may thus perform a short-circuit protection function. The limit current and the maximum current may be controlled by controlling the thickness of the metal layer. The metal layer may be plated or deposited on the base film. A smaller thickness of the metal layer may cause the limit current and/or maximum current of the negative electrode current collectors to become lower, thereby improving the stability of a lithium battery in the event of a short-circuit. A lead tab may be added on the metal layer for connection to the outside. The lead tab may be welded to the metal layer or a stacked structure of the metal layer/base film by an ultrasonic welding method, a laser welding method, a spot welding method, etc. The base film and/or the metal layer are melted during welding, and thereby causing the metal layer to be electrically connected to a lead tab. To more firmly weld the metal layer and the lead tab, a metal chip may be added between the metal layer and the lead tab. The metal chip may be a flake of the same material as the metal of the metal layer. The metal chip may be, for example, a metal foil, a metal mesh, etc. The metal chip may be, for example, an aluminum foil, a copper foil, a stainless steel (SUS) foil, etc. The lead tab may be welded to a stacked structure of a metal chip/metal layer or to a stacked structure of a metal chip/metal layer/base film by placing the metal chip on the metal layer, and then welding the metal layer to the lead tab. While the base film, the metal layer, and/or the metal chip are being melted during welding, the metal layer or a stacked structure of a metal layer/metal chip may be electrically connected to the lead tab. A metal chip and/or a lead tab may be added on a portion of the metal layer. The base film may have a thickness of, for example, about 1 μm to about 50 μm, about 1.5 μm to about 50 μm, about 1.5 μm to about 40 μm, or about 1 μm to about 30 μm. When the base film has the aforementioned thickness range, the weight of the electrode assembly may be reduced more effectively. A melting point of the base film may be, for example, about 100° C. to about 300° C., about 100° C. to about 250° C., or about 100° C. to about 200° C. The base film may be melted to connect easily with the lead tab in welding process of the lead tab due to having the melting point in the above-described range. To improve adhesion between the base film and the metal layer, a surface treatment such as corona treatment may be performed on the base film. The metal layer may have a thickness of, for example, about 0.01 μm to about 3 μm, about 0.1 μm to about 3 μm, about 0.1 μm to about 2 μm, about 0.1 μm to about 1.8 μm, or about 0.1 μm to about 1.5 μm. When the metal layer has a thickness within the range above, the stability of the electrode assembly may be secured while maintaining conductivity. The metal chip may have a thickness of, for example, about 2 μm to about 10 μm, about 2 μm to about 7 μm, or about 4 μm to about 6 μm. When the metal chip has a thickness within the range above, a connection between the metal layer and the lead tab may be more easily performed. When the negative electrode current collector 21 has such a structure, the weight of the electrode may be reduced, resulting in improvement of energy density.

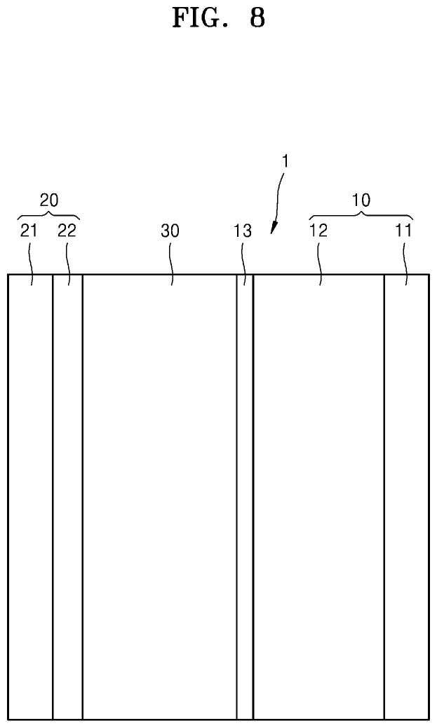

Referring to FIG. 8, the all-solid-state secondary battery 1 according to an embodiment, includes a second solid electrolyte 30, a positive electrode 10 disposed on one side of the second solid electrolyte 30, and a negative electrode 20 disposed on the other side of the second solid electrolyte 30. The positive electrode 10 includes a positive electrode active material layer 12 contacting the second solid electrolyte 30 and a positive electrode current collector 11 contacting the positive electrode active material layer 12, and the negative electrode 20 includes a negative electrode active material layer 22 contacting the second solid electrolyte 30 and a negative electrode current collector 21 contacting the negative electrode active material layer 22. An interlayer 13 is placed between the positive electrode 10 and the second solid electrolyte 30.

The all-solid-state secondary battery 1 is completed by, for example, forming each of the positive electrode active material layer 12 and the negative electrode active material layer 22 on each sides of the second solid electrolyte layer 30, and respectively forming the positive electrode current collector 11 and the negative electrode current collector 21 on the positive electrode active material layer 12 and on the negative active material layer 22. Alternatively, the all-solid-state secondary battery 1 is completed by, for example, sequentially stacking the negative electrode active material layer 22 on the negative electrode current collector 21, the second solid electrolyte layer 30, the positive electrode active material layer 12, and the positive electrode current collector 11, in the stated order.

### All-Solid-State Secondary Battery: Second Type

A second type is an all-solid-state battery having a precipitated-type negative electrode.

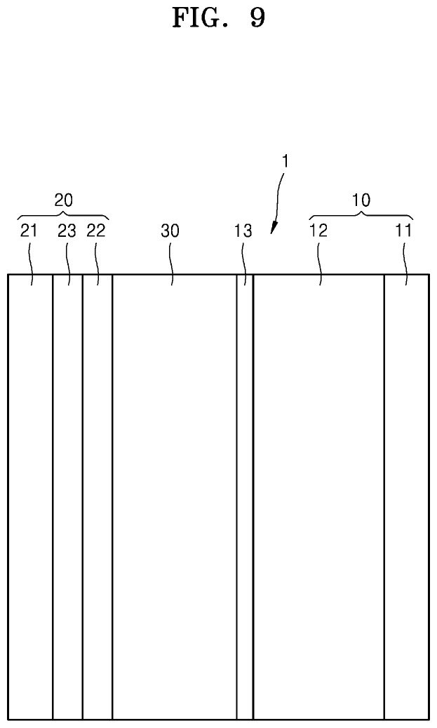

FIGS. 8 and 9 are each a schematic view of an all-solid-state battery including a precipitated-type negative electrode according to an embodiment. In the all-solid-state battery including the precipitated-type negative electrode, an initial charge capacity of the negative electrode active material layer at the time of initial charging is, for example, at most about 50%, at most about 40%, at most about 30%, at most about 20%, at most about 10%, at most about 5%, or at most about 1% of the initial charge capacity of the positive electrode active material layer. An all-solid-state secondary battery 1 includes, for example, a positive electrode 10 containing a positive electrode active material layer 12 disposed on a positive electrode current collector 11; a negative electrode 20 containing a negative electrode active material layer 22 disposed on a negative electrode current collector 21; and a second solid electrolyte 30 disposed between the positive electrode 10 and the negative electrode 20. An interlayer 13 is disposed between the positive layer 10 and the second solid electrolyte 30.

An all-solid battery according to another embodiment may be prepared as follows.

A positive electrode and a second solid electrolyte layer are prepared in the same manner as the all-solid-state secondary battery having a non-precipitated type negative electrode as described above.

Next, a negative electrode is prepared.

Referring to FIGS. 8 and 9, the negative electrode 20 includes the negative electrode current collector 21 and the negative electrode active material layer 22 disposed on the negative electrode current collector 21, and the negative active material layer 22 includes, for example, a negative electrode active material and a binder.

The negative electrode active material included in the negative electrode active material layer 22 has, for example, a particulate form. The particulate negative electrode active material has an average particle diameter of, for example, about 4 μm or less, about 10 nm to about 4 μm, about 10 nm to about 2 μm, about 10 nm to about 1 μm, or about 10 nm to about 900 nm. When the negative electrode active material has an average particle diameter within the range above, reversibly absorbing and/or desorbing lithium may be more easily performed during charging and discharging. The average particle diameter of the negative electrode active material is, for example, a median diameter (D50) as measured by using a laser scattering particle size distribution analyzer.

The negative electrode active material included in the negative electrode active material layer 22 includes, for example, a carbon-based (e.g., carbon) negative electrode active material, a metal or metalloid negative electrode active material, or a combination thereof.

The carbon-based negative electrode active material is particularly amorphous carbon. The amorphous carbon is, for example, carbon black (CB), acetylene black (AB), furnace black (FB), ketjen black (KB), graphene, etc., but is not limited thereto. Any suitable amorphous carbon classified as amorphous carbon in the related technical art, may be used. The amorphous carbon is a carbon that does not have crystallinity, or has a very low crystallinity and is distinguished from a crystalline carbon or a graphite-based carbon.

The metal or metalloid negative electrode active material includes gold (Au), platinum (Pt), palladium (Pd), silicon (Si), silver (Ag), aluminum (Al), bismuth (Bi), tin (Sn), zinc (Zn), or a combination thereof. For example, since nickel does not form an alloy with lithium, nickel is not a metal negative electrode active material.

The negative electrode active material layer 22 includes a single negative electrode active material among the aforementioned negative electrode active materials, or includes a mixture of a plurality of different negative electrode active materials. For example, the negative electrode active material layer 22 solely includes amorphous carbon, or includes gold (Au), platinum (Pt), palladium (Pd), silicon (Si), silver (Ag), aluminum (Al), bismuth (Bi), tin (Sn), zinc (Zn), or a combination thereof. Alternatively, the negative electrode active material layer 22 includes a mixture of an amorphous carbon and gold (Au), platinum (Pt), palladium (Pd), silicon (Si), silver (Ag), aluminum (Al), bismuth (Bi), tin (Sn), zinc (Zn), or a combination thereof. A mixing ratio in a mixture of amorphous carbon, and gold, etc., is a weight ratio of, for example, about 10:1 to about 1:2, about 5:1 to about 1:1, or about 4:1 to about 2:1, but is not necessarily limited thereto. The mixing ratio is selected depending on desired characteristics of an all-solid battery 1. The all-solid battery 1 has the aforementioned composition of the negative electrode active material, and thus has further improved cycle characteristics.

The negative active material included in the negative electrode active material layer 22 includes, for example, a mixture of a first particle composed of amorphous carbon and a second particle composed of a metal or metalloid. The metal or metalloid includes, for example, gold (Au), platinum (Pt), palladium (Pd), silicon (Si), silver (Ag), aluminum (Al), bismuth (Bi), tin (Sn), zinc (Zn), etc. The metalloid is, in other words, a semiconductor.

An amount of the second particle is about 8 wt % to about 60 wt %, about 10 wt % to about 50 wt %, about 15 wt % to about 40 wt %, or about 20 wt % to about 30 wt %, with respect to total weight of the mixture. When the amount of the second particle falls within the range above, the all-solid battery 1 has, for example, further improved cycle characteristics.

A binder included in the negative electrode active material layer 22 is, for example, styrene-butadiene rubber (SBR), polytetrafluoroethylene, polyvinylidene fluoride, polyethylene, vinylidene fluoride/hexafluoropropylene copolymer, polyacrylonitrile, polymethyl methacrylate, etc. However, the binder is not limited thereto, and any suitable binder available in the related art may be used. The binder may be composed of a single binder or a plurality of different binders.

The negative electrode active material layer 22 includes the binder and is thus stabilized on the negative electrode current collector 21. Furthermore, a crack in the negative electrode active material layer 22 is suppressed in spite of changes in volume and/or relative positions of the negative electrode active material layer 22 during charging and discharging. For example, when the negative electrode active material layer 22 does not include the binder, it is possible for the negative electrode active material layer 22 to be easily separated from the negative electrode current collector 21. In a portion of the negative electrode current collector 21 which is exposed by detachment of the negative electrode active material layer 22 from the negative electrode current collector 21, the negative electrode current collector 21 comes into contact the solid electrolyte layer 30, and thus it is highly likely that short-circuiting occurs. The negative electrode active material 22 is prepared by, for example, applying a slurry in which materials constituting the negative electrode active material layer are dispersed, onto the negative electrode current collector and drying the slurry. The negative electrode active material may be stably dispersed in the slurry by including a binder in the negative electrode active material layer 22. When the slurry is applied onto the negative electrode current collector 21 by, for example, a screen-printing method, clogging of a screen (for example, clogging of a screen due to an aggregate of the negative electrode active material) may be suppressed.

The negative electrode active material layer 22 may further include an additive such as a filler, a coating agent, a dispersant, or an ionic conductivity aid used in a typical all-solid-state battery 1.

A thickness of the negative electrode active material layer 22 is, for example, about 50% or less, about 40% or less, about 30% or less, about 20% or less, about 10% or less, or about 5% or less of a thickness of the positive electrode active material layer 12. The negative electrode active material layer 22 has a thickness of, for example, about 1 μm to about 20 μm, about 2 μm to about 10 μm, or about 3 μm to about 7 μm. When the negative electrode active material layer 22 has a thickness in the range above, an all-solid-state battery having improved cycle characteristics may be prepared.

When the negative electrode active material layer 22 has a reduced thickness, for example, the charge capacity of the negative electrode active material layer 22 decreases. The charge capacity of the negative electrode active material layer 22 is, for example, at most about 50%, at most about 30%, at most about 10%, at most about 5%, at most about 2%, or at most about 1% of the charge capacity of the positive electrode active material layer. The charge capacity of the negative electrode active material layer 22 is, for example, about 0.1% to about 50%, about 0.1% to about 40%, about 0.1% to about 20%, about 0.1% to about 10%, about 0.1% to about 5%, or about 0.1% to about 2% of charge capacity of the positive electrode active material layer 12. When charge capacity of the negative electrode active material layer 22 is within the range above, and the thickness of the negative electrode active material layer 22 is within the range above, an all-solid-state battery having suppressed lithium dendrite formation and improved cycle characteristics may be prepared.

The charge capacity of the positive electrode active material layer 12 is obtained by multiplying the specific charge capacity (mAh/g) of the positive electrode active material by the mass of the positive electrode active material in the positive electrode active material layer 12. When multiple types of positive electrode active materials are used, the specific charge capacity multiplied by the mass of each positive electrode active materials is calculated, and a sum of these values is used as the charge capacity of the positive electrode active material layer 12. The charge capacity of the negative electrode active material layer 22 is also calculated in the same manner. That is, the charge capacity of the negative electrode active material layer 22 is obtained by multiplying the specific charge capacity (mAh/g) of the negative electrode active material by the mass of the negative electrode active material in the negative electrode active material layer 22. When multiple types of negative electrode active materials are used, the charge capacity density multiplied by the mass of each negative electrode active material is calculated, and a sum of these values is used as the charge capacity of the negative electrode active material layer 22. Herein, the specific charge capacities of the positive electrode active material and negative electrode active material are capacities estimated by using an all-solid-state half-cell using a lithium metal as a counter electrode. The capacities of the positive electrode active material layer 12 and the negative electrode active material layer 22 are directly measured by a charge capacity measurement using the all-solid-state half-cell. The specific charge capacity is calculated by dividing of the measured charging capacity by the mass of each active material. Unlike what is described above, the charge capacities of the positive electrode active material layer 12 and the negative electrode active material layer 22 may be initial charge capacities measured during charging in a first cycle.

Referring to FIG. 9, an all-solid-state battery 1 may further include, for example, a metal layer 23 disposed between the negative electrode current collector 21 and the negative electrode active material layer 22. The metal layer 23 may be a metal foil or a plated metal layer. The metal layer 23 may include lithium or a lithium alloy. Accordingly, the metal layer 23 acts, for example, as a lithium reservoir. Lithium alloy may be, for example, Li—Ag alloy, Li—Au alloy, Li—Al alloy, Li—Sn alloy, Li—In alloy, Li—Zn alloy, Li—Ge alloy, Li—Si alloy, Li—Bi alloy, Li—Ga alloy, Li—Na alloy, Li—K alloy, Li—Te alloy, Li—Mg alloy, Li—Mo alloy, Li—Sn—Bi alloy, Li—Sn—Ag alloy, Li—Sn—Na alloy, Li—Sn—K alloy, Li—Sn—Ca alloy, Li-Te—Ag alloy, Li-Sb—Ag alloy, Li—Sn—Sb alloy, Li—Sn—V alloy, Li—Sn—Ni alloy, Li—Sn—Cu alloy, Li—Sn—Zn alloy, Li—Sn—Ga alloy, Li—Sn—Ge alloy, Li—Sn—Sr alloy, Li—Sn—Y alloy, Li—Sn—Ba alloy, Li—Sn—Au alloy, Li—Sn—La alloy, Li—Al—Ga alloy, Li—Mg—Sn alloy, Li—Mg—Al alloy, Li—Mg—Si alloy, Li—Mg—Zn alloy, Li—Mg—Ga alloy, Li—Mg—Ag alloy, or a combination thereof.

Although not particularly limited, the metal layer 23 has a thickness of, for example, about 1 μm to about 200 μm, about 1 μm to about 100 μm, about 1 μm to about 70 μm, about 1 μm to about 50 μm, about 1 μm to about 30 μm, or about 1 μm to about 20 μm. When the thickness of the metal layer 23 is excessively thin, the metal layer 23 is difficult to serve as a lithium reservoir. When the metal layer 23 has a thickness within the range above, an all-solid-state battery having excellent cycle characteristics may be prepared without increase in mass and volume of the all-solid-state battery 1. The metal layer 23 is, for example, a metal foil having a thickness within the range above.

In the all-solid-state battery 1a, the metal layer 23 is disposed, for example, between the negative electrode current collector 21 and the negative electrode active material layer 22 before assembly of the all-solid-state battery 1, or deposited between the negative electrode current collector 21 and the negative electrode active material layer 22 by charging after assembly of the all-solid-state battery 1. When the metal layer 23 is disposed between the negative electrode current collector 21 and the negative electrode active material layer 22 before assembly of the all-solid-state battery 1, the metal layer 23 is a metal layer including lithium, and thus acts as a lithium reservoir. For example, a lithium foil is disposed between the negative electrode current collector 21 and the negative electrode active material layer 22 before assembly of the all-solid-state battery 1. Therefore, the all-solid-state battery including the metal layer 23 has further improved cycle characteristics. When the metal layer 23 is deposited by charging after assembly of the all-solid-state battery 1, the metal layer 23 is not included in assembly of the all-solid-state battery 1, and therefore the energy density of the all-solid-state battery 1 is increased. For example, when charging the all-solid-state battery 1, the solid secondary battery 1 is charged to exceed the charge capacity of the negative electrode active material layer 22. That is, the negative electrode active material layer 22 is overcharged. Lithium may be absorbed into the negative electrode active material layer 22 at the initial stage of charging. The negative electrode active material included in the negative electrode active material layer 22 forms an alloy or a compound with lithium ion migrated from the positive electrode layer 10. When the negative electrode active material layer 22 is charged to exceed the capacity, lithium is deposited on a rear surface of the negative electrode active material layer 22, that is, between the negative electrode current collector 21 and the negative electrode active material layer 22. The corresponding metal layer is formed by the deposited lithium. The metal layer 23 is a metal layer composed mainly of lithium (that is, a metal lithium). This result is achieved, for example, by making the negative electrode active material included in the negative electrode active material layer 22, of materials that forms an alloy or compound with lithium. During discharging, lithium in the negative electrode active material 22 and the metal layer 23, that is lithium in the metal layer, ionizes and migrates toward the positive electrode layer 10. Accordingly, lithium may be used as a negative electrode active material in an all-solid-state battery 1. Furthermore, since the negative electrode active material layer 22 covers the metal layer 23, the negative electrode active material layer 23 serves as a protective layer of the metal layer and at the same time serves to suppress the deposition and growth of lithium dendrite. Therefore, the all-solid-state secondary battery 1 is suppressed from short-circuiting and capacity reduction, and as a result, the all-solid-state secondary battery 1 has improved cycle characteristics. Additionally, when the metal layer 23 is disposed by charging after assembly of the all-solid-state battery 1, the negative electrode current collector 21, the negative electrode active material layer 22, and a region therebetween are, for example, Li-free regions which do not include lithium (Li) in an initial state or in a state after discharging of the all-solid-state battery 1.

The negative electrode current collector 21 comprises, for example, a material which does not react with lithium, that is, does not form an alloy and a compound with lithium. A material of the negative electrode current collector 21 may be copper (Cu), stainless steel, titanium (Ti), iron (Fe), cobalt (Co), and nickel (Ni), etc., but is not necessarily limited thereto, and any suitable material used in the related art as an electrode current collector may be used. The negative electrode current collector 21 may be composed of the aforementioned single metal, an alloy of two or more metals, or a cladding material. The negative electrode current collector 21 is, for example, in a plate or foil form.

An all-solid-state battery 1 may further include, for example, a thin film (not illustrated) including an element that may form an alloy with lithium on the negative electrode current collector 21. The thin film is disposed between the negative electrode current collector 21 and the negative electrode active material layer 22. The thin film includes, for example, an element that may form an alloy with lithium. The element that may form an alloy with lithium is, for example, gold (Au), silver (Ag), zinc (Zn), tin (Sn), indium (In), silicon (Si), bismuth (Bi), or a combination thereof, but is not limited thereto. Any suitable element that may form an alloy with lithium in related art may be used. The thin film consists of one among these metals, or consists of an alloy of different types of metals. Since the thin film is disposed on the negative electrode current collector 21, for example, a deposited metal layer 23 between the thin film and the negative electrode active material layer 22 may have flatter deposited shape, and the all-solid-state battery 1 may have further improved cycle characteristics.

The thin film has a thickness of, for example, about 1 nm about to 800 nm, about 10 nm about to 700 nm, about 50 nm about to 600 nm, or about 100 nm about to 500 nm. When the thickness of the thin film is within the range above, an all-solid-state battery 1 having improved energy density and cycle characteristics by providing the function of the thin film may be prepared. The thin film is disposed on a negative electrode current collector 21 by, for example, a vacuum deposition method, a sputtering method, a plating method, etc. However, the forming method of the thin film is not limited thereto, and any suitable method capable of forming a thin film in related art may be used.

Hereinafter, a method of providing (e.g., preparing) a positive electrode-solid electrolyte assembly according to an embodiment will be described.

First, a positive electrode is prepared by using a positive electrode active material, a first solid electrolyte, and a conductive material.

The positive electrode may be formed by a dry or wet method.

When the positive electrode is formed by a dry method, the positive electrode active material, the first solid electrolyte, and the conductive material were mixed in a mixer to obtain a composite positive electrode powder and the powder was stacked on top of a substrate or an interlayer to prepare the positive electrode.

When the positive electrode is formed by a wet method, the positive electrode active material, the first solid electrolyte, and the conductive material were mixed to prepare a composition. The composition is applied on the positive electrode current collector and dried to form the positive electrode active material layer, thereby obtaining the positive electrode.

An amount of the first solid electrolyte is about 10 parts by weight to about 70 parts by weight, about 20 parts by weight to about 60 parts by weight, or about 30 parts by weight to about 55 parts by weight, with respect to 100 parts by weight of the positive electrode active material. When the amount of the first solid electrolyte is within the range above, an electrochemical cell having excellent capacity and energy density, and improved cycle characteristics may be prepared.

An amount of the conductive material is about 1 part by weight to 10 parts by weight, or about 2 parts by weight to about 7 parts by weight with respect to 100 parts by weight of the positive electrode active material. When the amount of the conductive material is within the range above, the conductivity of the positive electrode is excellent.

The composition may further include a binder.

An amount of the binder may be about 1 part by weight to 10 parts by weight, or about 2 parts by weight to about 7 parts by weight with respect to 100 parts by weight of the positive electrode active material. When the amount of the binder falls within the aforementioned range, the positive electrode active material layer may have further improved adhesion to the positive electrode current collector, thereby suppressing energy density of the positive electrode active material layer from being decreased.

Additionally, an interlayer is formed using a preliminary interlayer material.

Apart from this, a positive electrode-solid electrolyte subassembly according to an embodiment is prepared including processes of preparing the second solid electrolyte, and then stacking the positive electrode, the interlayer, and the second solid electrolyte.

The preliminary interlayer material is a starting material used for forming a metal sulfide, a metal oxide, a lithium metal oxide, a metal halide, a metal nitride, a metal carbonate, or a combination thereof, which is the interlayer material.

The preliminary interlayer material is, for example, copper (Cu), tin (Sn), cobalt (Co), nickel (Ni), zinc (Zn), titanium (Ti), cadmium (Cd), molybdenum (Mo), palladium (Pd), rhodium (Rh), zirconium (Zr), vanadium (V), hafnium (Hf), tungsten (W), aluminum (Al), or a combination thereof.

In forming of the interlayer using the preliminary interlayer material, the interlayer is formed by sputtering or coating the preliminary interlayer material onto the substrate or the positive electrode.

According to an embodiment, in forming of the interlayer using the preliminary interlayer material, copper is sputtered to form an interlayer containing copper sulfide, zinc is sputtered to form an interlayer containing zinc oxide, or zirconium is sputtered to form an interlayer containing zirconium oxide.

According to another embodiment, a composition containing an interlayer material such as copper sulfide, zirconium dioxide, or zinc oxide is obtained, and the obtained composition is applied on a positive electrode or a substrate and dried to form an interlayer. When the interlayer is formed on the substrate, the interlayer is separated from the substrate and stacked on the positive electrode to prepare a positive electrode-solid electrolyte assembly in which the interlayer is disposed between the positive electrode according to an embodiment and the solid electrolyte. In an aspect, the method of preparing the positive electrode-solid electrolyte subassembly may comprise: providing a positive electrode comprising a positive electrode active material, a first solid electrolyte, and a conductive material; treating a preliminary interlayer material to form an interlayer material; providing a second solid electrolyte; and disposing the interlayer material between the positive electrode and the second solid electrolyte to prepare the positive electrode-solid electrolyte subassembly. In an aspect, the treating of the preliminary interlayer material comprises sputtering or coating the preliminary interlayer material to form the interlayer material on a substrate or the positive electrode.

The inventive concept will be described in more detail through Examples and Comparative Examples hereafter.

### Examples

(Preparation of first solid electrolyte)

### Preparation Example 1

ZrCl₄, HoCl₃, and LiCl were mixed at a stoichiometric ratio of 4:1:11 to obtain Li_{2.2}Ho_{0.2}Zr_{0.8}Cl₆(LHZC), the mixture was added in a planetary mill with zirconia ball to perform a milling for 15 minutes at 400 rotation per minute (rpm). After performing milling, the resultant mixture was left for 5 minutes, followed by another milling for 48 hours to obtain the first solid electrolyte Li_{2.2}Ho_{0.2}Zr_{0.8}Cl₆(LHZC).

### Example 1

Li₂Ni_{0.95}Co_{0.25}Al_{0.25}O (NCA, 660 mg) which is a positive electrode active material, LHZC (330 mg) which is a first solid electrolyte, and carbon nanofiber (10 mg) which is a conductive material were mixed in a blade mixer to obtain a composite positive electrode powder.

In a stainless steel (SUS) electrode of a cylinder cell, an In layer (a thickness of 50 μm) as a negative electrode, and a sulfide-based solid electrolyte (Li₆PS₅Cl (LiPSCI), 75 g, 400 μm) as a second solid electrolyte were filled, and then Cu which is a preliminary interlayer material was stacked by a sputter coater to a thickness of 10 nm to form a preliminary interlayer. Subsequently, the resultant stacked product was maintained for 1 hour, then the composite positive electrode powder (50 mg) obtained according to the above process was stacked, a SUS electrode was placed, and then pressed under 500 MPa to prepare an all-solid-state battery. A set capacity of the positive electrode was 5 mAhcm⁻².

### Example 2

An all-solid-state battery was prepared in the same manner as in Example 1, except for stacking Cu with a sputter coater to a thickness of 20 nm instead of a thickness of 10 nm.

### Example 3

An all-solid-state battery was prepared in the same manner as in Example 1, except for stacking Zr, which is a preliminary interlayer material, in place of Cu, which is a preliminary interlayer material, with a sputter coater.

### Example 4

An all-solid-state battery was prepared in the same manner as in Example 1, except for stacking Zr with a sputter coater to a thickness of 20 nm instead of a thickness of 10 nm.

### Example 5 and 6

All-solid-state batteries were prepared in the same manner as in Example 1, except for stacking Cu with a sputter coater to a thickness of 50 nm and 100 nm, respectively, instead of a thickness of 10 nm.

### Comparative Example 1

An all-solid-state battery was prepared in the same manner as in Example 1, except that both of processes of stacking Cu to a thickness of 10 nm with a sputter coater and maintaining it for 1 hour were not performed.

### Comparative Example 2

An all-solid-state battery was prepared in the same manner as in Example 1, except for using gold (Au) in place of copper (Cu).

### Evaluation Example 1: XPS Analysis

XPS analysis for a surface of an interlayer/solid electrolyte structure, measured by XPS after Cu sputter coating, was performed under a condition of Table 1 below in a preparation process of the all-solid-state batteries prepared according to Examples 1 and 3.

TABLE 1

| | Spectral analysis |
|---|---|
| Experiments | (Monochromatic Al-Kα (hv = 1486.6 eV)) |
| Survey scan | Pass energy: 280 eV (step 1 eV) |
| | (7 min for each scan) |
| HR Core level scan | Pass energy: 23.5 eV (energy step of 0.1 eV) |
| (Core level scan) | X-ray: beam spot 100 μm |
| Ar⁺- ion sputtering | N/A |
| (Ion sputtering) | |

Results of XPS evaluation are shown in FIGS. 2A to 2C and FIGS. 3A to 3C.

FIG. 2A shows observation results by XPS measurement for a surface after Cu sputter coating according to Example 1. Referring to this, a peak due to CuS was detected at 161.3 eV by S2p XPS. Additionally, as shown in FIG. 2B, a peak due to CuS was detected at 931.7 eV by Cu 2p XPS. Furthermore, it can be seen a surface of the sulfide-based solid electrolyte was oxidized and a thin film of CuS which is an interlayer was formed.

FIGS. 3A to 3C show observation results by XPS measurement for a surface after Zr sputter coating according to Example 3.

As shown in FIG. 3A, in a S2p XPS observation, a compound with Zr was not detected. Additionally, as shown in FIG. 3B, a peak due to ZrO₂ was detected at 181.7 eV by Zr 3d XPS, and a peak due to Zr metal was not detected. As shown in FIG. 3C, in an O1XPS observation, a peak due to ZrO₂ was detected.

As a result, it is confirmed that an interlayer containing a thin film of ZrO₂ is formed.

### Evaluation Example 2: Evaluation of Charging and Discharging Characteristics

Charging and discharging characteristics were evaluated by a following charge/discharge test in all-solid-state batteries prepared according to Example 1 and Comparative Example 1.

During a first charge/discharge cycle, a constant charging was executed at a current rate of 0.1 C until the voltage of battery reached 3.6 V, followed by a constant voltage charging at a constant voltage of 3.6 V until the current reached a current of 0.1 C. Subsequently, a constant current discharging was executed at a current rate of 0.1 C until the battery voltage reached 1.9 V. The C rate is a discharge rate of a cell, and is obtained by dividing a total capacity of the cell by a total discharge period of time of 1 hour, e.g., a C rate for a battery having a discharge capacity of 1.6 ampere-hours would be 1.6 amperes. The total capacity is determined by a discharge capacity on the 1st cycle. 0.1 C or C/10 refers to a current that will fully discharge the battery in 10 hours.

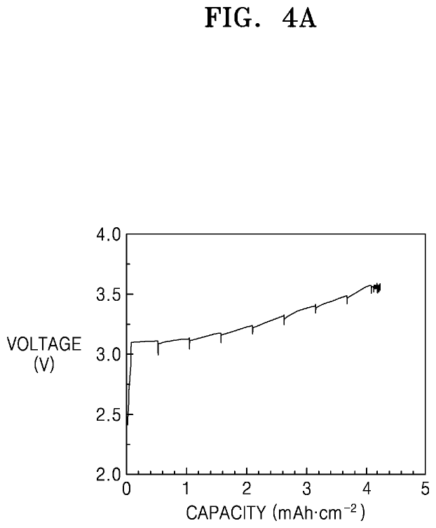

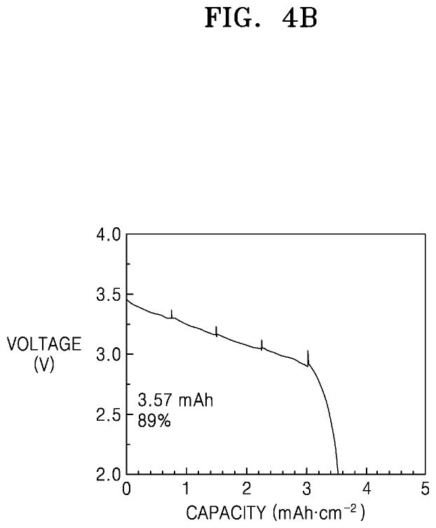

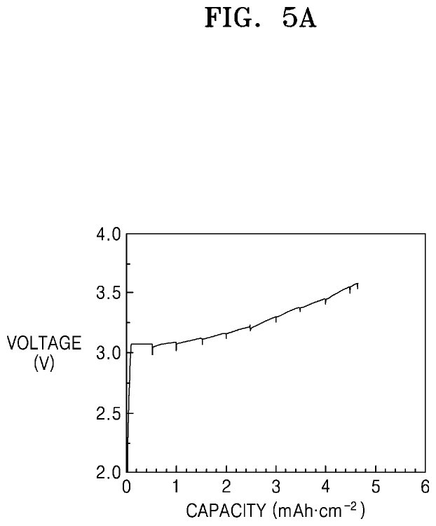

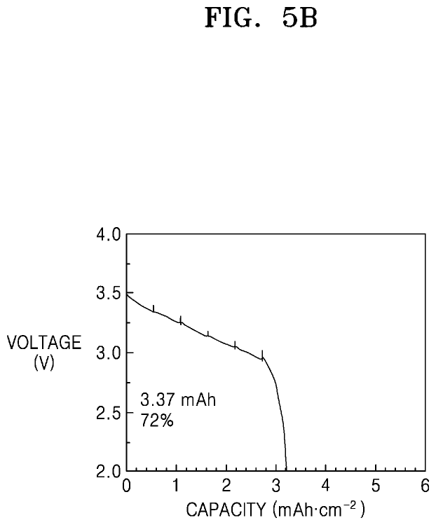

Charging and discharging characteristics of an all-solid-state battery according to Example 1 is the same as illustrated in FIGS. 4A and 4B. Additionally, charging and discharging characteristics of the all-solid-state battery according to Comparative Example 1 is the same as illustrated in FIGS. 5A and 5B.

Referring to FIGS. 4A and 4B, the all-solid-state battery according to Example 1 showed a stable charging and discharging behavior by forming an interlayer, and the discharge capacity compared to the charge capacity increased, thereby showing charge/discharge efficiency of about 89% at 3.57 mAh/cm².

In contrast, the all-solid-state battery according to Comparative Example 1 has a structure in which a positive electrode and a solid electrolyte are in direct contact, and the discharge capacity compared to the charge capacity is small, as illustrated in FIGS. 5A and 5B, thereby showing charge/discharge efficiency of about 72% at 3.37 mAh/cm².

### Evaluation Example 3: Evaluation of Charging and Discharging Characteristics

The discharge capacity and charge/discharge efficiency were investigated by a following charge/discharge test in the all-solid-state batteries prepared according to Example 1 and Comparative Example 1.

During a first charge/discharge cycle, a constant charging was executed at a current rate of 0.1 C until the voltage of battery reached 3.6 V, followed by a constant voltage charging at a constant voltage of 3.6 V until the current reached a current of 0.1 C. Subsequently, a constant current discharging was executed at a current rate of 0.1 C until the battery voltage reached 1.9 V.

As an evaluation result, the discharge capacity and charge/discharge efficiency were evaluated, and the results thereof were listed in Table 2.

In table 2 below, Q_{D} is the discharge capacity, and Q_{C} is the charge capacity. Additionally, charge/discharge efficiency is represented by Equation 1 below.

TABLE 2

| | | | Discharging | |
|---|---|---|---|---|
| | Composition of | Thickness | capacity | Q_{D}/Q_{C} |
| Classification | intemediate layer | (nm) | (mAh · cm⁻²) | (%) |
| Example 1 | CuS | 10 | 3.57 | 89 |
| Example 2 | CuS | 20 | 3.32 | 98 |
| Example 3 | ZrO₂ | 10 | 3.80 | 83 |
| Comparative | None | None | 3.27 | 72 |
| Example 1 | | | | |
| Comparative | Au | 10 | 2.94 | 69 |
| Example 2 | | | | |

$$\\ \begin{matrix}Charge / discharge efficiency ( \% ) = {Q}_{D} / {Q}_{C} \times 100 \% & Equation 1\end{matrix}$$

As shown in Table 2, all-solid-state batteries according to Examples 1 to 3 have an increased discharge capacity than Comparative Examples 1 and 2, and have improved charge/discharge efficiency than Comparative Example 1.

In contrast, a conductive thin film was formed in the all-solid battery of Comparative Example 2, thereby reducing the discharge capacity and charge/discharge efficiency.

### Evaluation Example 4: Lifetime Characteristics

The lifetime characteristics were evaluated for the all-solid secondary batteries of Example 1 and Comparative Example 1. Charge/discharge test was performed at 25° C.

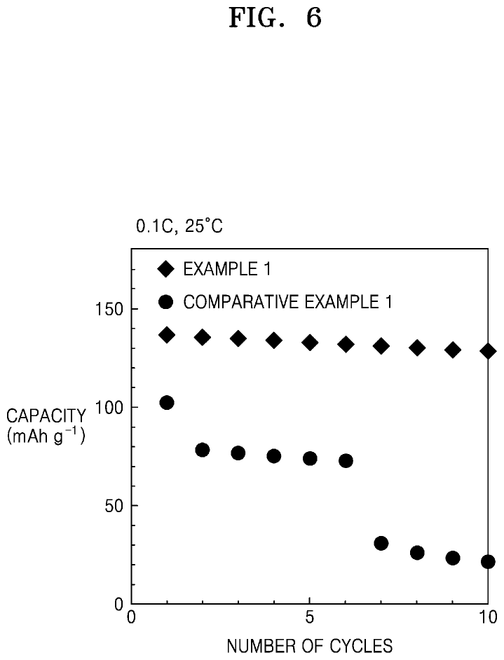

A constant current charging was executed at a current rate of 0.1 C until the voltage reached 4.2 V, and then a constant current discharging was executed until the voltage reached 2.5 V. The charging/discharging cycles were executed repeatedly 40 times. For each cycle, once the battery was charged and discharged, and then the battery rested for about 10 minutes. A capacity retention of all-solid-state secondary batteries prepared according to Example 10 and Comparative Example 6 was illustrated in FIG. 6. The capacity retention is calculated by Equation 2.

### Equation 2

Capacity retention (%)=[discharge capacity of 10^{th} cycle/discharge capacity of first cycle]×100%

Changes in capacity in all-solid batteries manufactured according to Example 1 and Comparative Example 14 were investigated and the investigated results were illustrated in FIG. 6.

Referring to FIG. 6, it was confirmed that, in the cell according to Comparative Example 1, a short-circuit occurred at an early stage of a cell operation, followed by stop of the cell operation, and in the cell according to Example 1, the cell was operated stably even when driven for at least 10 cycles.

An embodiment has been described with reference to Examples illustrated in figures, and it is understood that the present disclosure should not be limited to these embodiments, but various changes, modifications, and other equivalent embodiments can be made by one ordinary skilled in the art. Therefore, the true scope of technical protection of the disclosure should be determined by the technical spirit of the attached claims.

In a positive electrode-solid electrolyte subassembly according to an embodiment, an electron movement from the sulfide-based solid electrolyte to the positive electrode containing the halide solid electrolyte is prevented to suppress a side reaction between the positive electrode and the solid electrolyte, thereby suppressing a decomposition reaction occurred on a surface of the halide solid electrolyte. As a result, an electrochemical cell having the positive electrode-solid electrolyte subassembly may have improved charge/discharge efficiency without a decrease in energy density.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A positive electrode-solid electrolyte subassembly comprising:
a positive electrode comprising
a positive electrode active material,
a conductive material, and
a first solid electrolyte;
a second solid electrolyte disposed on the positive electrode; and
an interlayer disposed between the positive electrode and the second solid electrolyte,
wherein the interlayer comprises an interlayer material,
the interlayer material having an electrical conductivity less than an electrical conductivity of the conductive material of the positive electrode, and wherein the first solid electrolyte comprises
lithium and a metal, and
a sulfur-free lithium-ion conductor.

2. The positive electrode-solid electrolyte subassembly of claim 1,
wherein the sulfur-free lithium-ion conductor has a sulfur content of less than 1 mole percent, based on a total content of the sulfur-free lithium-ion conductor.

3. The positive electrode-solid electrolyte subassembly of claim 1,
wherein the interlayer material has an electrical conductivity of less than 1 Siemens per meter.

4. The positive electrode-solid electrolyte subassembly of claim 1,
wherein the interlayer material comprises a metal sulfide, a metal oxide, a lithium metal oxide, a metal halide, a metal nitride, a metal carbonate, or a combination thereof.

5. The positive electrode-solid electrolyte subassembly of claim 4,
wherein the metal sulfide comprises copper, tin, cobalt, nickel, zinc, titanium, cadmium, molybdenum, palladium, rhodium, zirconium, vanadium, hafnium, tungsten, aluminum, or a combination thereof,
the metal oxide comprises zirconium dioxide, aluminum oxide, silicon dioxide, zinc oxide, zirconium oxide, hafnium dioxide, titanium dioxide, tin dioxide, or a combination thereof,
the lithium metal oxide comprises lithium zirconium oxide, lithium titanium oxide, or a combination thereof,
the lithium halide comprises lithium chloride, lithium fluoride, lithium bromide, lithium iodide, or a combination thereof,
the metal carbonate comprises lithium carbonate, magnesium carbonate, sodium carbonate, calcium carbonate, barium carbonate, or a combination thereof, and the metal nitride comprises lithium nitride, titanium nitride, tantalum nitride, molybdenum nitride, vanadium nitride, or a combination thereof.

6. The positive electrode-solid electrolyte subassembly of claim 1,
wherein the interlayer has a thickness of about 1 nanometer to about 1 micrometer.

7. The positive electrode-solid electrolyte subassembly of claim 1,
wherein the second solid electrolyte is a sulfide solid electrolyte, an oxide solid electrolyte, or a combination thereof.

8. The positive electrode-solid electrolyte subassembly of claim 1,
wherein the first solid electrolyte comprises a solid ion conductor compound represented by Formula 1: 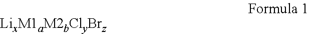
wherein M1 comprises an alkali metal, an alkaline earth metal, a transition metal, or a combination thereof,
M2 comprises a lanthanide element, a non-lanthanide element having an oxidation number of 3, or a combination thereof,
0<x<3.5,0≤a<1.5, 0<b<1.5, 0≤y<6, 0≤z<6, and 0<y+z≤6.

9. The positive electrode-solid electrolyte subassembly of claim 8,
wherein M2 is La, Ce, Pr, Nd, Pm, Sm, Eu, Gd, Tb, Dy, Ho, Er, Tm, Yb, Lu, Sc, Y, In, or a combination thereof.

10. The positive electrode-solid electrolyte subassembly of claim 8,
wherein M1 is Na, K, Rb, Cs, Fr, Be, Mg, Ca, Sr, Ba, Ra, Sc, Y, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, In, Ti, Ge, Sn, Pb, Sb, Bi, Po, or a combination thereof.

11. The positive electrode-solid electrolyte subassembly of claim 8,
wherein Formula 1 is represented by Formula 2: 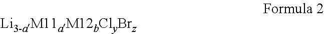
wherein, in Formula 2,
M11 is Na, K, Rb, Cs, Fr, Be, Mg, Ca, Sr, Ba, Ra, Sc, Y, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, In, Ti, Ge, Sn, Pb, Sb, Bi, Po, or a combination thereof,
M12 is La, Ce, Pr, Nd, Pm, Sm, Eu, Gd, Tb, Dy, Ho, Er, Tm, Yb, Lu, Sc, Y, In, or a combination thereof,
0≤a′<1.5, 0<b<1.5, 0≤y<6, 0≤z<6, 0<y+z≤6.

12. The positive electrode-solid electrolyte subassembly of claim 1,
wherein the first solid electrolyte comprises LiₓHoCl_{y} wherein 0<x<3.5, and 0<y≤6, LiₓCeCl_{y} wherein 0<x<3.5, and 0<y≤6, LiₓPrCl_{y} wherein 0<x<3.5, and 0<y≤6, LiₓNdCl_{y} wherein 0<x<3.5, and 0<y≤6, LiₓPmCl_{y} wherein 0<x<3.5, and 0<y≤6, LiₓSmCl_{y} wherein 0<x<3.5, and 0<y≤6, LiₓEuCl_{y} wherein 0<x<3.5, and 0<y≤6, LiₓGdCl_{y} wherein 0<x<3.5, and 0<y≤6, LiₓTbCl_{y}wherein 0<x<3.5, and 0<y≤6, LiₓDyCl_{y}wherein 0<x<3.5, and 0<y≤6, LiₓErCl_{y} wherein 0<x<3.5, and 0<y≤6, LiₓTmCl_{y} wherein 0<x<3.5, and 0<y≤6, LiₓYbCl_{y} wherein 0<x<3.5, and 0<y≤6, LiₓInCl_{y} wherein 0<x<3.5, and 0<y≤6, LiₓYCl_{y} wherein 0<x<3.5, and 0<y≤6, or LiₓLuCl_{y}wherein 0<x<3.5, and 0<y≤6;
LiₓM1ₐHoCl_{y}wherein 0<x<3.5, O≤a<1.5, and 0<y≤6, LiₓM1ₐCeCl_{y}wherein 0<x<3.5, 0≤a<1.5, and 0<y≤6, LiₓM1ₐPrCl_{y} wherein 0<x<3.5, O≤a<1.5, and 0<y≤6, LiₓM1ₐNdCl_{y}wherein 0<x<3.5, O≤a<1.5, and 0<y≤6, LiₓM1ₐPmCl_{y} wherein 0<x<3.5, O≤a<1.5, and 0<y≤6, LiₓM1ₐSmCl_{y}wherein 0<x<3.5, O≤a<1.5, and 0<y≤6, LiₓM1ₐEuCl_{y}wherein 0<x<3.5, 0≤a<1.5, and 0<y≤6, LiₓM1ₐGdCl_{y} wherein 0<x<3.5, O≤a<1.5, and 0<y≤6, LiₓM1ₐTbCl_{y}wherein 0<x<3.5, O≤a<1.5, and 0<y≤6, LiₓM1ₐDyCl_{y} wherein 0<x<3.5, O≤a<1.5, and 0<y≤6, LiₓM1ₐErCl_{y}wherein 0<x<3.5, O≤a<1.5, and 0<y≤6, LiₓM1ₐTmCl_{y} wherein 0<x<3.5, 0≤a<1.5, and 0<y≤6, LiₓM1ₐYbCl_{y} wherein 0<x<3.5, O≤a<1.5, and 0<y≤6, LiₓM1ₐlnCl_{y} wherein 0<x<3.5, O≤a<1.5, and 0<y≤6, LiₓM1ₐYCl_{y}wherein 0<x<3.5, O≤a<1.5, and 0<y≤6, LiₓM1ₐLuCl_{y} wherein 0<x<3.5, O≤a<1.5, and 0<y≤6;
LiₓHoBr_{z} wherein 0<x<3.5, and 0<z≤6, LiₓCeBr_{z} wherein 0<x<3.5, and 0<z≤6, LiₓPrBr_{z} wherein 0<x<3.5, and 0<z≤6, LiₓNdBr_{z} wherein 0<x<3.5, and 0<z≤6, LiₓPmBr_{z} wherein 0<x<3.5, and 0<z≤6, LiₓSmBr_{z} wherein 0<x<3.5, and 0<z≤6, LiₓEuBr_{z} wherein 0<x<3.5, and 0<z≤6, LiₓGdBr_{z} wherein 0<x<3.5, and 0<z≤6, LiₓTbBr_{z} wherein 0<x<3.5, and 0<z≤6, LiₓDyBr_{z} wherein 0<x<3.5, and 0<z≤6, LiₓErBr_{z} wherein 0<x<3.5, and 0<z≤6, LiₓTmBr_{z} wherein 0<x<3.5, and 0<z≤6, LiₓYbBr_{z}wherein 0<x<3.5, and 0<z≤6, LixInBry wherein 0<x<3.5, and 0<y≤6, LiₓYBr_{y} wherein 0<x<3.5, and 0<y≤6, LiₓLuBr_{z} wherein 0<x<3.5, and 0<z<6;
LiₓM1ₐHoBr_{z} wherein 0<x<3.5, O≤a<1.5, and 0<z≤6, LiₓM1ₐCeBr_{z} wherein 0<x<3.5, O≤a<1.5, and 0<z≤6, LiₓM1ₐPrBr_{z} wherein 0<x<3.5, O≤a<1.5, and 0<z≤6, LiₓM1ₐNdBr_{z} wherein 0<x<3.5, O≤a<1.5, and 0<z≤6, LiₓM1ₐPmCl_{y} wherein 0<x<3.5, 0≤a<1.5, and 0<y≤6, LiₓM1ₐSmBr_{z} wherein 0<x<3.5, O≤a<1.5, and 0<z≤6, LiₓM1ₐEuBr_{z} wherein 0<x<3.5, O≤a<1.5, and 0<z≤6, LiₓM1ₐGdBr_{z} wherein 0<x<3.5, O≤a<1.5, and 0<z≤6, LiₓM1ₐTbBr_{z} wherein 0<x<3.5, O≤a<1.5, and 0<z≤6, LiₓM1ₐDyBr_{z} wherein 0<x<3.5, 0≤a<1.5, and 0<z≤6, LiₓM1ₐErBr_{z} wherein 0<x<3.5, O≤a<1.5, and 0<z≤6, LiₓM1ₐTm wherein 0<x<3.5, O≤a<1.5, and 0<y≤6, LiₓM1ₐYbBr_{z}wherein 0<x<3.5, O≤a<1.5, and 0<z≤6, LiₓM1ₐlnBr_{z} wherein 0<x<3.5, O≤a<1.5, and 0<z≤6, LiₓM1ₐYBr_{z} wherein 0<x<3.5, 0≤a<1.5, and 0<z≤6, LiₓM1ₐLuBr_{z} wherein 0<x<3.5, O≤a<1.5, and 0<z≤6, or a combination thereof, and
M1 includes an alkali metal, an alkaline earth metal, a transition metal, or a combination thereof.

13. The positive electrode-solid electrolyte subassembly of claim 1,
wherein the second solid electrolyte comprises a compound having an argyrodite-type crystal structure and represented by Formula 4: 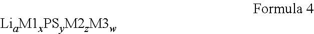
wherein, in Formula 4,
M1 is a metal element of Groups 1 to 15 of the Periodic Table, or a combination thereof, other than Li,
M2 is an element of Group 17 of the Periodic Table, or a combination thereof,
M3 is SOₙ, and
4≤a≤8, 0≤x<1, 3≤y≤7, 0<z≤2, 0≤w<2, and 1.5≤n≤5.

14. The positive electrode-solid electrolyte subassembly of claim 1,
wherein the second solid electrolyte is a sulfide solid electrolyte comprising Li₂S—P₂S₅, Li₂S—P₂S₅—LiX wherein X is a halogen element, Li₂S—P₂S₅—Li₂O, Li₂S—P₂S₅—Li₂O-Lil, Li₂S-SiS₂, Li₂S-SiS₂—Lil, Li₂S-SiS₂—LiBr, Li₂S-SiS₂—LiCl, Li₂S-SiS₂—B₂S₃—Lil, Li₂S-SiS₂—P₂S₅-Lil, Li₂S-B₂S₃, Li₂S—P₂S₅—ZₘSₙ wherein m and n are positive numbers, and Z is one of Ge, Zn, or Ga, Li₂S-GeS₂, Li₂S-SiS₂—Li₃PO₄, Li₂S-SiS₂—LiₚMO_{q} wherein p and q are positive numbers, and M is one of P, Si, Ge, B, Al, Ga, or In, Li₇₋ₓPS₆₋ₓClₓ wherein 0<x<2, Li₇₋ₓPS₆₋ₓBrₓ wherein 0<x<2, Li₇—ₓPS₆₋ₓlₓ wherein 0<x<2, or a combination thereof.

15. The positive electrode-solid electrolyte subassembly of claim 1, wherein when the interlayer is analyzed by X-ray photoelectron spectroscopy,
a first doublet peak corresponding to an S2p peak of sulfur appears at a binding energy range of about 160 electronvolts to about 164 electronvolts, and
the first doublet peak comprises a first peak at about 160 electronvolts to about 162 electronvolts and a second peak at about 162.1 electronvolts to about 164 electronvolts.

16. The positive electrode-solid electrolyte subassembly of claim 1, wherein when the interlayer is analyzed by X-ray photoelectron spectroscopy,
a second doublet peak corresponding to an O1s peak of oxygen appears at a binding energy range of about 528 electronvolts to about 532 electronvolts, and
the second doublet peak comprises a third peak at about 528 electronvolts to about 530 electronvolts and a fourth peak at about 530.1 electronvolts to about 532 electronvolts.

17. An electrochemical cell comprising:
the positive electrode-solid electrolyte subassembly of claim 1; and
a negative electrode,
wherein the solid electrolyte of the positive electrode-solid electrolyte subassembly is disposed between the positive electrode and the negative electrode.

18. The electrochemical cell of claim 17,
wherein the negative electrode comprises lithium metal or a lithium alloy.

19. The electrochemical cell of claim 17,
wherein the electrochemical cell is an all-solid-state secondary battery.

20. A method of preparing a positive electrode-solid electrolyte subassembly, the method comprising:
providing a positive electrode comprising a positive electrode active material, a first solid electrolyte, and a conductive material;
treating a preliminary interlayer material to form an interlayer;
providing a second solid electrolyte; and
disposing the interlayer between the positive electrode and the second solid electrolyte to prepare the positive electrode-solid electrolyte subassembly.
